(19) United States
(12) Patent Application Publication
(10) Pub. No.: US 2009/0244578 A1
(43) Pub. Date: Oct. 1, 2009

(54) IMAGE RECORDING APPARATUS AND METHOD

(76) Inventor: Hiroyuki SASAYAMA, Kanagawa-Ken (JP)

Correspondence Address: BIRCH STEWART KOLASCH & BIRCH, PO BOX 747, FALLS CHURCH, VA, 22040-0747, US

(21) Appl. No.: 12/413,322

(22) Filed: Mar. 27, 2009

(30) Foreign Application Priority Data
Mar. 28, 2008 (JP) 2008-087672

(51) Int. Cl. H04N 1/60

(52) U.S. Cl. 358/1.9

(57) ABSTRACT

The image recording apparatus records an image on a recording medium. The image recording apparatus includes: a recording head which has a plurality of recording elements; a conveyance device which conveys at least one of the recording head and the recording medium so that the recording head and the recording medium move relatively to each other; a characteristics information acquisition device which acquires characteristics information that indicates recording characteristics of the respective recording elements, the characteristics information including recording point positional information and recording-incapable element information; an information selection device which selects the recording point positional information to be used in calculation of correction values for use in generating image data that suppresses density non-uniformity caused by the recording characteristics in accordance with the recording-incapable element information; a correction value calculation device which calculates the correction values from the recording point positional information selected by the information selection device; a correction processing device which corrects the image data by using the correction values obtained by the correction value calculation device; and a drive control device which controls driving of the recording head in accordance with the image data corrected by the correction processing device.

### BACKGROUND OF THE INVENTION

1. Field of the Invention

The present invention relates to an image recording apparatus and an image recording method, and more particularly to image correction processing technology which is suitable for correcting density variations caused by variation in characteristics among a plurality of recording elements in a recording head having the recording elements.

2. Description of the Related Art

An image recording apparatus (inkjet printer) has been used which includes an inkjet type of recording head having a plurality of ink ejection ports (nozzles). In this type of image recording apparatus, problems of image quality are liable to arise due to the occurrence of density variations (density non-uniformities) in the recorded image caused by variations in the ejection characteristics of the nozzles. FIG. 24 is an illustrative diagram showing a schematic view of examples of variations in the ejection characteristics of the nozzles, and density variations appearing in recording results.

In FIG. 24, reference numeral 300 represents a line head, reference numeral 302-i (where i=1 to 8) represents a nozzle, reference numeral 304-i (i=1 to 8) represents a dot formed by a droplet ejected from the nozzle 302-i (i=1 to 8). Here, it is supposed that the recording medium, such as recording paper, is conveyed in a direction perpendicular to the breadthways direction of the line head 300 (the nozzle arrangement direction) (namely, in the direction of arrow S), and the nozzle arrangement direction in the line head 300 is taken to be the main scanning direction, while the direction of relative conveyance of the recording medium with respect to the line head 300 (the direction S) is taken to be the sub-scanning direction.

In the example shown in FIG. 24, a depositing position error occurs at the nozzle 302-3, which is third from the left (namely, the droplet ejected from the nozzle 302-3 deposits on the recording medium at a position diverging from the originally intended depositing position in the leftward direction in FIG. 24), and a droplet volume error occurs at the sixth nozzle 302-6 (namely, the droplet ejected from the nozzle 302-6 has a greater droplet volume than the originally intended volume). In this case, density non-uniformity streaks occur at the positions in the print image corresponding to the nozzles 302-3 and 302-6 producing the depositing position error and the droplet volume error (namely, the positions indicated by A and B in FIG. 24).

In the case of a serial (shuttle) scanning type of image recording apparatus, which performs image recording by driving a recording head to scan a plurality of times over the prescribed print region, it is possible to avoid density non-uniformities by means of a commonly known multi-pass printing method, but in the case of a single pass system (line head system) which records images by means of a single scanning action, it is difficult to avoid density non-uniformities.

Since it is difficult to completely prevent variations in ejection characteristics among the nozzles in terms of the process of manufacturing the recording head, then various technologies for correcting the variations have been proposed (see, Japanese Patent Application Publication No. 2007-125877 and U.S. Pat. No. 7,484,824).

With the object of eliminating stripe-shaped non-uniformities (banding) caused by a so-called “flight deflection effect”, Japanese Patent Application Publication No. 2007-125877 discloses a method which controls the amount of banding avoidance processing applied on the basis of the distance between a line where banding occurs and other lines.

U.S. Pat. No. 7,484,824 describes outputting a test pattern, obtaining depositing position error data from the print results, using this depositing position error data to define a density profile D(x) which incorporates the error characteristics of respective nozzles, converting this density profile into a function T(f) by Fourier transform and then calculating a density correction coefficient by minimizing the low-frequency component of the power spectrum of this function.

However, with the technology described in Japanese Patent Application Publication No. 2007-125877, there is a problem in that suitable avoidance processing is not possible in cases where a line where banding occurs relates to a nozzle suffering ejection failure. On the other hand, U.S. Pat. No. 7,484,824 does not mention the specific content of the processing in the event of a nozzle suffering ejection failure.

### SUMMARY OF THE INVENTION

The present invention has been contrived in view of these circumstances, an object thereof being to eliminate the problems described above by providing an image recording apparatus and an image recording method whereby highly accurate density correction (suppression of banding) can be achieved, and a computer readable medium having embodied thereon an image processing program which is valuable in correction processing of the apparatus and method.

In order to attain the aforementioned object, the present invention is directed to an image recording apparatus which records an image on a recording medium, comprising: a recording head which has a plurality of recording elements; a conveyance device which conveys at least one of the recording head and the recording medium so that the recording head and the recording medium move relatively to each other; a characteristics information acquisition device which acquires characteristics information that indicates recording characteristics of the respective recording elements, the characteristics information including recording point positional information and recording-incapable element information; an information selection device which selects the recording point positional information to be used in calculation of correction values for use in generating image data that suppresses density non-uniformity caused by the recording characteristics in accordance with the recording-incapable element information; a correction value calculation device which calculates the correction values from the recording point positional information selected by the information selection device; a correction processing device which corrects the image data by using the correction values obtained by the correction value calculation device; and a drive control device which controls driving of the recording head in accordance with the image data corrected by the correction processing device.

According to this aspect of the present invention, the characteristics information of the recording elements includes at least the recording point positional information and the recording-incapable element information, and the recording point positional information that is to be used in calculating the correction values is determined (selected) on the basis of the recording-incapable element information. Thus, the positional information used to calculate the correction values is decided appropriately, in accordance with the state of occurrence of recording elements that are incapable of recording, and therefore it is possible to achieve good image correction even in the event of recording-incapable recording elements occurring.

The “characteristics information acquisition device” may acquire information by storing information relating to recording failure positions, previously, in a storage device such as a memory, and then reading out the required information, or it may acquire information relating to recording characteristics by printing an actual test pattern, or the like, and then reading in and analyzing the print results. Considering that the recording characteristics change over time, a desirable mode is one in which the information is updated at suitable times.

The processing for correcting the image data according to the present invention is desirably carried out in respect of the image data at the stage before the screening process (digital halftoning for converting the data to binary or multiple-value dot data).

In other words, screening is carried out on the basis of the image data which has been corrected by the correction processing device, thereby converting the data to binary dot data or multiple-value dot data (multiple values corresponding to the different dot sizes) which corresponds to the recording elements of the recording head. An image is formed on the recording medium by controlling the recording head on the basis of this dot data.

An inkjet recording apparatus which serves as an image recording apparatus according to an embodiment of the present invention comprises: a liquid ejection head (corresponding to a “recording head”) having a droplet ejection element row in which a plurality of droplet ejection elements (corresponding to “recording elements”) are arranged in a row, each droplet ejection element including a nozzle for ejecting an ink droplet in order to form a dot and a pressure generating device (piezoelectric element, heating element, or the like) which generates an ejection pressure; and an ejection control device which controls the ejection of droplets from the recording head on the basis of dot data (ink ejection data) generated from the image data. An image is formed by recording dots on a recording medium by means of the droplets ejected from the nozzles.

A compositional example of a recording head is a full line type head having a recording element row in which a plurality of recording elements are arranged through a length corresponding to the full width of the recording medium. In this case, a mode may be adopted in which a plurality of relatively short recording head modules having recording element rows which do not reach a length corresponding to the full width of the recording medium are combined and joined together, thereby forming recording element rows of a length that correspond to the full width of the recording medium.

A full line type head is usually arranged in a direction that is perpendicular to the relative feed direction (relative conveyance direction) of the recording medium, but a mode may also be adopted in which the recording head is arranged following an oblique direction that forms a prescribed angle with respect to the direction perpendicular to the conveyance direction.

The “recording medium” indicates a medium on which an image is recorded by means of the action of the recording head (this medium may also be called an image forming medium, print medium, image receiving medium, or, in the case of an inkjet recording apparatus, an ejection medium or ejection receiving medium, or the like). This term includes various types of media, irrespective of material and size, such as continuous paper, cut paper, sealed paper, resin sheets, such as OHP sheets, film, cloth, an intermediate transfer body, a printed circuit board on which a wiring pattern, or the like, is printed by means of an inkjet recording apparatus, and the like.

The “conveyance device” may include a mode where the recording medium is conveyed with respect to a stationary (fixed) recording head, or a mode where a recording head is moved with respect to a stationary recording medium, or a mode where both the recording head and the recording medium are moved.

When forming color images by means of an inkjet head, it is possible to arrange recording heads for inks of a plurality of colors (recording liquids), or it is possible to eject inks of a plurality of colors from a single recording head.

Furthermore, the present invention is not limited to a full line head, and may also be applied to a serial (shuttle) scanning type recording head (a recording head which ejects droplets while moving reciprocally in a direction substantially perpendicular to the conveyance direction of the recording medium).

Preferably, the correction value calculation device calculates density non-uniformity caused by the recording characteristics of the recording elements and calculates density correction coefficients forming the correction values in accordance with correction conditions which reduce a low-frequency component of a power spectrum that represents spatial frequency characteristics of the density non-uniformity.

Irregularities in the density of a recorded image (density non-uniformities) can be represented by the intensity of the spatial frequency characteristics (power spectrum), and the visibility of a density non-uniformity can be evaluated by means of the low-frequency component of the power spectrum. Since the density correction coefficients are specified by using conditions under which the differential coefficient at the frequency origin point (f=0) of the power spectrum after correction using the density correction data becomes substantially zero, then the intensity of the power spectrum becomes a minimum at the frequency origin point and the power spectrum restricted to a low value in the vicinity of the origin (in other words, in the low-frequency region). Accordingly, highly accurate correction of non-uniformity can be achieved.

Preferably, the information selection device excludes the recording point positional information corresponding to a recording-incapable element from the calculation of the correction values.

By calculating the correction values without using the recording point positional information of the recording-incapable recording elements, it is possible to carry out suitable image correction by using the recording point positional information for adjacent points on either side of the position where the element is not capable of recording.

In order to attain the aforementioned object, the present invention is also directed to a method of recording an image on a recording medium by a plurality of recording elements of a recording head, while moving the recording head and the recording medium relatively to each other by conveying at least one of the recording head and the recording medium, the method comprising: a characteristics information acquisition step of acquiring characteristics information that indicates recording characteristics of the respective recording elements, the characteristics information including recording point positional information and recording-incapable element information; an information selection step of selecting the recording point positional information to be used in calculation of correction values for use in generating image data that suppresses density non-uniformity caused by the recording characteristics in accordance with the recording-incapable element information; a correction value calculation step of calculating the correction values from the recording point positional information selected in the information selection step; a correction processing step of correcting the image data by using the correction values obtained in the correction value calculation step; and a drive control step of controlling driving of the recording head in accordance with the image data corrected in the correction processing step.

In order to attain the aforementioned object, the present invention is also directed to a computer readable medium having embodied thereon a computer program for causing a computer to operate: a characteristics information acquisition function of acquiring characteristics information that indicates recording characteristics of a plurality of recording elements of a recording head, the characteristics information including recording point positional information and recording-incapable element information; an information selection function of selecting the recording point positional information to be used in calculation of correction values for use in generating image data that suppresses density non-uniformity caused by the recording characteristics in accordance with the recording-incapable element information; a correction value calculation function of calculating the correction values from the recording point positional information selected by the information selection function; and a correction processing function of correcting the image data by using the correction values obtained by the correction value calculation function.

The computer readable medium according to this aspect of the present invention may be used for operating a central processing unit (CPU) incorporated into a printer, and it may also be used for a computer system, such as a personal computer.

Furthermore, the computer readable medium may contain stand-alone application software, or it may include a part of another application, such as image editing software. This computer readable medium can be a CD-ROM, a magnetic disk, or other information storage medium (an external storage device), and the computer readable medium may be provided to a third party in the form of such an information storage medium, or a download service for the program may be offered by means of a communications circuit, such as the Internet.

According to the present invention, it is possible to correct density non-uniformities caused by variations in the recording characteristics of recording elements, with high accuracy, and hence images of high quality can be formed.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is an illustrative diagram showing a density profile before correction of density non-uniformity according to an embodiment of the present invention;

FIG. 2 is an illustrative diagram showing a state after correction of density non-uniformity according to an embodiment of the present invention;

FIG. 3 is a graph of density profiles of an actual print model and a 6 function type of print model;

FIG. 4 is an explanatory diagram of the calculation of correction values in the event of an ejection failure according to the present embodiment;

FIG. 5 shows a flowchart of the calculation of density correction coefficients in the present embodiment;

FIG. 6 shows a flowchart of image output in the present embodiment;

FIGS. 7A to 7C show a flowchart of the calculation of density correction and ejection failure correction coefficients according to an embodiment;

FIG. 8 is a general schematic drawing showing one example of a dot deposition rate table;

FIG. 9 is a general schematic drawing showing one example of a droplet ejection volume table;

FIG. 10 shows a flowchart of a sequence for processing image data;

FIG. 11 shows a flowchart of the contents of non-uniformity correction step;

FIG. 12 shows a flowchart of an N-value conversion process using error diffusion;

FIG. 13 is an explanatory diagram of an error calculation buffer used in an error diffusion method;

FIG. 14 is an explanatory diagram of a cumulative error value adding step in the error diffusion method;

FIG. 15 is a diagram showing an example of a multiple-value threshold value table used in the error diffusion method;

FIGS. 16A and 16B are explanatory diagrams of a step of diffusing an error value in the error diffusion method;

FIG. 17 is an explanatory diagram of a step of updating the error accumulation buffer in preparation for changing the line that is the object of calculation;

FIG. 18 is a general schematic drawing of an inkjet recording apparatus according to an embodiment of the present invention;

FIG. 19 is a principal plan diagram of the peripheral area of a print unit in the inkjet recording apparatus shown in FIG. 18;

FIG. 20A is a plan view perspective diagram showing a compositional example of a print head, FIG. 20B is a principal enlarged view of FIG. 20A, and FIG. 20C is a plan view perspective diagram showing a further example of the structure of a full line head;

FIG. 21 is a cross-sectional view along line 21-21 in FIGS. 20A and 20B;

FIG. 22 is an enlarged view showing a nozzle arrangement in the print head shown in FIGS. 20A and 20B;

FIG. 23 is a principal block diagram showing the system configuration of the inkjet recording apparatus; and

FIG. 24 is a schematic drawing for describing the relationship between variation in the ejection characteristics of the nozzles, and density non-uniformity, in the related art.

### DETAILED DESCRIPTION OF THE PREFERRED EMBODIMENTS

### Description of Principles of Correction

Firstly, technology for carrying out correction of banding by using information on the droplet depositing positions will be described. In the correction method described here, when correcting the depositing position error of a particular nozzle, correction is performed by using N peripheral nozzles which surround that nozzle. In terms of basic principles, it is possible to use the method described in U.S. Pat. No. 7,484,824.

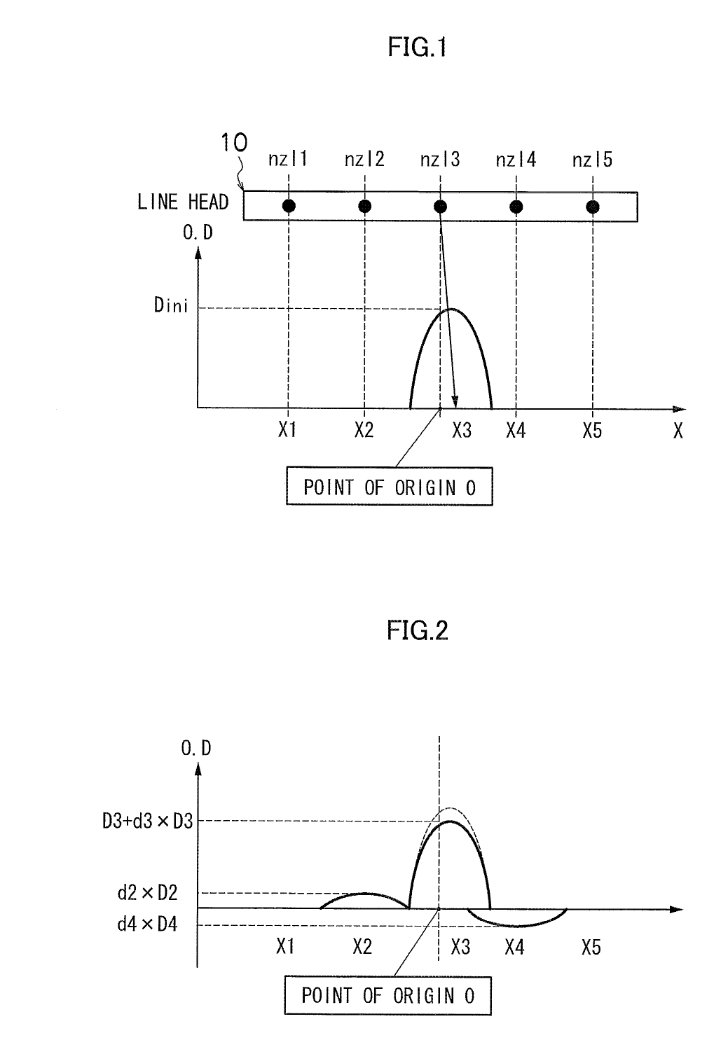

FIG. 1 is a diagram showing a state before correction. In FIG. 1, the third nozzle (nzl3) from the left in a line head 10 (which is equivalent to a “recording head”) has a depositing position error, and hence the depositing position is displaced from the ideal depositing position (the origin O) in the rightward direction in the diagram (the main scanning direction indicated by the X axis in FIG. 1). Furthermore, the graph shown in the bottom part of FIG. 1 indicates the density profile in the nozzle column direction (main scanning direction), obtained by averaging the print density produced by the droplets ejected from each nozzle in the conveyance direction of the recording medium (the sub-scanning direction). Here, since correction relating to the printing by the nozzle nzl3 is considered in FIG. 1, the density outputs of the nozzles other than the nozzle nzl3 are not shown in FIG. 1. The horizontal axis (X axis) represents the position in the main scanning direction, and the vertical axis represents the optical density (O. D.).

The initial output density of each of the nozzles nzl1 to nzl5 is Dᵢ=D_{INI} (where i is the nozzle number of 1, 2, 3, 4 or 5, and D_{INI} is a uniform value), the origin O is set at the ideal depositing position of the nozzle nzl3, and the depositing position of each of the nozzles nzl1 to nzl5 is Xᵢ.

Here, Dᵢ represents the output optical density of the nozzle when averaged physically in the recording medium conveyance direction, and corresponds to the averaged density data D(i, j) of pixels (where i is the nozzle number, and j is the pixel number in the conveyance direction of the recording medium) that is calculated as an average with respect to “j”.

As shown in FIG. 1, the depositing position error of the nozzle nzl3 is represented by the divergence of the density output of the nozzle nzl3 (thick line) from the origin point O. The correction of this divergence in the output density is described below.

FIG. 2 is a diagram showing a state after correction. Here, the density output for the nozzle nzl3 is shown together with the correction components. In the case of FIG. 2, the number of nozzles used in correction is N=3, and the nozzles nzl2, nzl3 and nzl4 are weighted (multiplied) with density correction coefficients d2, d3 and d4, respectively. The density correction coefficients dᵢ described here are defined as D′ᵢ=Di+dᵢ×Dᵢ, where D′ᵢ are the output densities after correction.

In the present embodiment, the density correction coefficient of each nozzle is determined so as to minimize the visibility of the density non-uniformity.

It has been known that the visibility of a spatial structure, such as density non-uniformity, can be evaluated on the basis of the spatial frequency characteristics (see, for example, “Application of Fourier Analysis to the Visibility of Gratings”, Journal of Physiology, 197, 551 to 566 (1968) F. W. Campbell and J. G. Robson 1967, “Noise Perception in Electrophotography”, Journal of Applied Photographic Engineering 5: 190 to 196 (1979) R. P. Dooley ad R. Shaw), and it is clear that human vision has high sensitivity to low-frequency components, and this sensitivity declines as the frequency increases. In other words, it is suitable to use the low-frequency energy of the spatial frequency characteristics as a measure of the visibility of a density non-uniformity. Therefore, in the present embodiment, the density correction coefficient for each nozzle is determined so as to minimize the low-frequency component of the power spectrum.

The details of the derivation of the equation for specifying the density correction coefficient dᵢ are described later, but to state the result in advance, the density correction coefficient dᵢ corresponding to the depositing position error of a particular nozzle (correction object nozzle) is specified by means of the following equation:

$${d}_{i} = \{ \begin{matrix}\frac{{\prod }_{k} {x}_{k}}{{x}_{i} \cdot {\prod }_{k \neq i} ( {x}_{k} - {x}_{i} )} - 1 & ( for the correction object nozzle ) \\ \frac{{\prod }_{k} {x}_{k}}{{x}_{i} \cdot {\prod }_{k \neq i} ( {x}_{k} - {x}_{i} )} & ( for nozzles other than the correction object nozzle ) ,\end{matrix} \qquad ( 1 )$$

where xᵢ is the depositing position of each nozzle, taking the origin at the ideal depositing position of the correction object nozzle; and Π means that the product is found for the N nozzles used for correction.

### <Calculation of Density Correction Coefficients>

It is possible to logically derive the density correction coefficient for each nozzle from the conditions for minimizing the low-frequency component of the power spectrum of the density non-uniformity.

Firstly, a density profile D(x) incorporating the error characteristics of each nozzle is defined as:

$$D ( x ) = {\sum }_{i} {D}_{i} \cdot z ( x - {x}_{i} ) , \qquad ( 2 )$$

where i is the nozzle number, x is the positional coordinate on the medium (in the nozzle column direction), Dᵢ is the nozzle output density (the height of peak), z(x) is the standard density profile (where x=0 is the center of gravity), and xᵢ= x̅ᵢ+Δxᵢ is the depositing position of the i-th nozzle (the ideal position+the error).

The density profile D(x) of the image is the sum of the density profiles printed by the nozzles, and the print model represents the printing performed by each nozzle (the density profile printed by each nozzle). The print model is represented separately by the nozzle output density Dᵢ and the standard density profile z(x).

The standard density profile z(x) has a limited spread equal to the dot diameter in strict terms, but if the correction of positional errors is considered to be a problem of balancing divergences in the density, then the important element is the central position (depositing position) of the density profile and the spread of the density profile is a secondary factor. Hence, an approximation that converts the profile by means of a δ function is appropriate. When a standard density profile represented with a δ function is supposed, then an arithmetical treatment can be achieved readily, and a precise solution for the correction coefficients can be obtained.

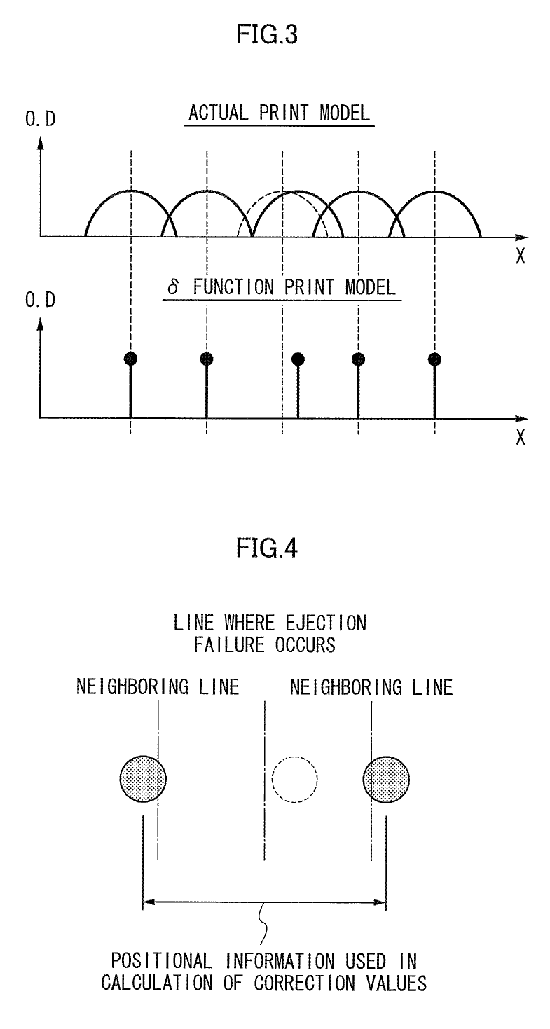

FIG. 3 shows a graph of density profiles of an actual print model and a δ function type of print model. The standard density profile is represented as approximation using the δ function model as:

z(x−xᵢ)=δ(x−xᵢ). (3)

In calculating the correction coefficients, it is considered that the depositing position error Δx₀ of a particular nozzle (i=0) is to be corrected by means of the N pieces of nozzles including the particular nozzle and the nozzles surrounding the particular nozzle. Here, the number of the nozzle to be corrected is i=0. Attention is paid to the fact that each of the surrounding nozzles may also have a prescribed depositing position error.

The numbers (indexes) of the N nozzles including the nozzle to be corrected (central nozzle) are represented as:

$$Nozzle index \text{:} i = - \frac{N - 1}{2} , … , - 1 , 0 , 1 , … , \frac{N - 1}{2} . \qquad ( 4 )$$

The number N must be an odd number in this expression, but in implementing the present invention, the number N is not necessarily limited to being an odd number.

The initial output density (the output density before correction) has a value only if i=0, and is represented as follows:

$${D}_{i} = \{ \begin{matrix}{D}_{INI} & ( i = 0 ) \\ 0 & ( i \neq 0 )\end{matrix} . \qquad ( 5 )$$

When the density correction coefficients are dᵢ, then the output densities D′ᵢ after correction are represented as follows:

$${D}_{i}^{′} = {D}_{i} + {d}_{i} \times {D}_{INI} = {d}_{i}^{′} \times {D}_{INI} , \\ where {d}_{i}^{′} = \{ \begin{matrix}{d}_{i} + 1 & ( i = 0 ) \\ {d}_{i} & ( i \neq 0 ) .\end{matrix} \qquad ( 6 )$$

In other words, when i=0, the corrected output density is the sum of the initial output density value and the correction value (dᵢ×D_{INI}), and when i≠0, the corrected output density is equal to the correction value only.

The depositing position xᵢ of each nozzle i is represented as:

xᵢ= x̅ᵢ+Δxᵢ, (7)

where x̅ᵢ is the ideal depositing position, Δxᵢ is the depositing position error, and the ideal depositing position of the correction object nozzle is set as the origin ( x̅₀=0).

When using a δ function type of print model, the density profile after correction is expressed as follows:

$$D ( x ) = {\sum }_{i = - ( N - 1 ) / 2}^{i = ( N - 1 ) / 2} {D}_{i}^{′} \cdot δ ( x - {x}_{i} ) = {D}_{INI} \cdot {\sum }_{i = - ( N - 1 ) / 2}^{i = ( N - 1 ) / 2} {d}_{i}^{′} \cdot δ ( x - {x}_{i} ) . \qquad ( 8 )$$

By Fourier transform on this equation, the following equation is obtained:

$$\begin{matrix}T ( f ) = {\int }_{- ∞}^{∞} D ( x ) \cdot {e}^{i fx} d x \\ = {\sum }_{i} {d}_{i}^{′} \cdot {\int }_{- ∞}^{∞} δ ( x - {x}_{i} ) \cdot {e}^{i fx} d x \\ = {\sum }_{i} {d}_{i}^{′} \cdot {e}^{i fx} ,\end{matrix} \qquad ( 9 )$$

where D_{INI} is omitted since it is a common constant.

Minimizing the visibility of density non-uniformities means minimizing the low-frequency components of the power spectrum expressed as:

Power spectrum=∫T(f)² df. (10)

This can be approximated arithmetically by taking the differential coefficients (of the first-order, the second-order, . . . ) for f=0 in T(f) to be zero. Since there are N unknown numbers d′ᵢ, then if conditions are used where the differential coefficients up to the (N−1)-th order are zero, and also including the condition for maintaining the direct current (DC) component, then all (N) of the unknown numbers d′ᵢ can be specified precisely. Thus, the following correction conditions are specified:

$$\begin{matrix}DC componen t \text{:} T ( f = 0 ) = 1 \\ ( condition for preserving the DC component ) ; & ( 11 ) \\ First \text{-} order coefficient \text{:} \frac{d}{d f} T ( f = 0 ) = 0 ; & ( 12 ) \\ Second \text{-} order coefficient \text{:} \frac{{d}^{2}}{d {f}^{2}} T ( f = 0 ) = 0 ; \\ … & ( 13 ) \\ ( N - 1 ) \text{-} th order coefficient \text{:} \frac{{d}^{N - 1}}{d {f}^{N - 1}} T ( f = 0 ) = 0. & ( 14 )\end{matrix}$$

In the δ function model, when the correction conditions are developed, N simultaneous equations relating to Di are reached by means of a simple calculation. When the correction conditions are rearranged, the following group of conditions (group of equations) is obtained:

Σdᵢ′=1; (15)

Σxᵢdᵢ′=0; (16)

Σxᵢ²dᵢ′=0; (17)

Σxᵢ^{N-1}dᵢ′=0. (18)

The meaning of this group of equations is that the first equation represents the preservation of the DC component and the second equation represents the preservation of the central position. The third and subsequent equations represent the fact that the (N−1)-th moment in the statistical calculation is zero.

The conditional equations thus obtained can be represented with a matrix format as follows:

$$( \begin{matrix}1 & … & 1 & … & … & 1 \\ {x}_{- ( N - 1 ) / 2} & … & {x}_{0} & … & … & {x}_{( N - 1 ) / 2} \\ {x}_{- ( N - 1 ) / 2}^{2} & … & {x}_{0}^{2} & & … & {x}_{( N - 1 ) / 2}^{2} \\ ⋮ & & & ⋰ & & ⋮ \\ ⋮ & & & & ⋰ & ⋮ \\ {x}_{- ( N - 1 ) / 2}^{N - 1} & … & {x}_{0}^{N - 1} & … & … & {x}_{( N - 1 ) / 2}^{N - 1}\end{matrix} ) ( \begin{matrix}{d}_{- ( N - 1 ) / 2}^{′} \\ ⋮ \\ ⋮ \\ {d}_{0}^{′} \\ ⋮ \\ {d}_{( N - 1 ) / 2}^{′}\end{matrix} ) = ( \begin{matrix}1 \\ 0 \\ ⋮ \\ 0 \\ ⋮ \\ 0\end{matrix} ) . \qquad ( 19 )$$

This coefficient matrix A is a so-called Vandermonde matrix, and it is known that this matrix equation can be converted to the following equation, by using the product of the differences:

$$\vert A \vert = {\prod }_{j > k} ( {x}_{j} - {x}_{k} ) . \qquad ( 20 )$$

It is hence possible to determine the precise solution of d′ᵢ using the Crammer's formula. The detailed sequence of the calculation is omitted here, but by means of algebraic calculation, the following solution is obtained:

$${d}_{i}^{′} = \frac{{\prod }_{k} {x}_{k}}{{x}_{i} \cdot {\prod }_{k \neq i} ( {x}_{k} - {x}_{i} )} . \qquad ( 21 )$$

Therefore, the correction coefficients dᵢ are determined as follows:

$${d}_{i} = \{ \begin{matrix}\frac{{\prod }_{k} {x}_{k}}{{x}_{i} \cdot {\prod }_{k \neq i} ( {x}_{k} - {x}_{i} )} - 1 & ( i = 0 ) \\ \frac{{\prod }_{k} {x}_{k}}{{x}_{i} \cdot {\prod }_{k \neq i} ( {x}_{k} - {x}_{i} )} & ( i \neq 0 ) .\end{matrix} \qquad ( 22 )$$

Thus, the precise solution for the density correction coefficients dᵢ is found, from the conditions where the differential coefficients at the origin of the power spectrum become zero. As the number of nozzles N used in the correction increases, the possibility of making the higher-order differential coefficients become zero increases, and hence, the low-frequency energy becomes smaller and the visibility of non-uniformities is reduced yet further.

In the present embodiment, the conditions where the differential coefficients become zero at the origin are used, but if the differential coefficients become sufficiently small values compared to the differential coefficients before the correction (such as 1/10 of the values before the correction), rather than being set completely to zero, it is still possible to make the low-frequency components of the power spectrum of the density non-uniformity sufficiently small. In other words, from the viewpoint of achieving conditions where the low-frequency components of the power spectrum are reduced to extent by which density non-uniformities become invisible, it is acceptable that the differential coefficients of the power spectrum at the origin are set to sufficiently small values (approximately 0), and that the range of each differential coefficient after correction can be set up to 1/10 of the absolute value of the differential coefficient before correction.

The foregoing description relates to the method of determining density correction coefficients relating to one particular nozzle (e.g., the nozzle nzl3 in FIG. 1). In actual practice, all of the nozzles in the head have some degree of depositing position errors, and therefore, it is desirable that corrections are performed in respect of all of these depositing position errors.

In other words, the aforementioned density correction coefficients for the surrounding N nozzles are determined with respect to each nozzle. Since the equations for minimizing the power spectra, which are described above and used when determining the density correction coefficients, are linear, then it is possible to superpose the equations for each nozzle. Therefore, the total density correction coefficient for a nozzle is determined by finding the sum of the density correction coefficients obtained as described above.

More specifically, if the density correction coefficient for a nozzle i in relation to the positional error of a nozzle k is set to be d(i, k), then the value of this d(i, k) is determined by the solution Dᵢ of equation (13), and the total density correction coefficient dᵢ for the nozzle i is obtained by linear combination of d(i, k) as follows:

$${d}_{i} = {\sum }_{k} d ( i , k ) . \qquad ( 23 )$$

In the present embodiment, d(i, k) is accumulated for the index k assuming that the depositing position errors of all of the nozzles are to be corrected, but it is also possible to adopt a composition in which a certain value ΔX_thresh is set previously as a threshold value, and correction is performed selectively by setting as objects for correction only those nozzles that have a depositing position error exceeding this threshold value of ΔX_thresh.

As stated above, the accuracy of correction is improved if the value of the number of nozzles N used for the correction is increased, but this also increases the breadth of change of the density correction coefficients and may lead to disruption of the reproduced image. Therefore, desirably, a limit range (a lower limit d_min to an upper limit d_max) is set for the correction coefficients in order to prevent the occurrence of image disruption, and the value N is set in such a manner that the total density correction coefficient determined by the above-described equation (23) comes within this limit range. In other words, the value N is set in such a manner that the relationship of d_min<dᵢ<d_max is satisfied. From experimental observation, it was revealed that image disruption does not occur provided that d_min≧−1 and d_max≦1.

### Correction Technology According to Embodiments of the Present Invention

The embodiment of the present invention uses the principles of the correction and the derivation of the density correction coefficients similar to the above-described method in U.S. Pat. No. 7,484,824, and further uses ejection failure nozzle information to determine the position information to be used in the calculation.

More specifically, as shown in FIG. 4, if there is an ejection failure nozzle, the positional information of an ejection failure line corresponding to the ejection failure nozzle is not used to the correction calculation but the position information of the adjacent lines corresponding to the adjacent nozzles that can perform ejection and deposition is used. Thus, the position information to be used in the calculation of the correction values is determined according to the ejection failure condition.

If a j-th nozzle is an ejection failure nozzle, the correction coefficients dᵢ are determined according to the equation (22) as follows:

$${d}_{i} = \{ \begin{matrix}\frac{{\prod }_{k} {x}_{k}}{{x}_{i} \cdot {\prod }_{( k \neq i ) and ( k \neq j )} ( {x}_{k} - {x}_{i} )} - 1 & ( \begin{matrix}when i is the correction \\ object nozzle\end{matrix} ) \\ \frac{{\prod }_{k} {x}_{k}}{{x}_{i} \cdot {\prod }_{( k \neq i ) and ( k \neq j )} ( {x}_{k} - {x}_{i} )} & ( \begin{matrix}when i is not the \\ correction object nozzle\end{matrix} ) .\end{matrix} \qquad ( 24 )$$

As shown in the equation (24), the density correction coefficients are calculated while excluding the information of the ejection failure nozzle.

Thereby, the distance between the two adjacent lines (depositing positions) across the ejection failure line is lengthened, and the density correction coefficients are determined to further thicken the density accordingly. Thus, it is possible to obtain the effect to correct the image defects due to the ejection failure.

### Flowchart of Calculating (Updating) Density Correction Coefficients

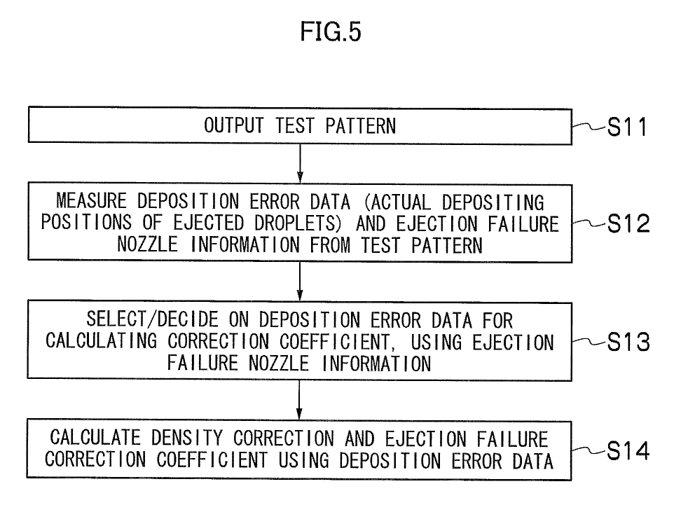

FIG. 5 shows a flowchart of the calculation of density correction coefficients in the present embodiment. The density correction coefficients do not have to be calculated each time an image is output, but rather it is sufficient to calculate them only when the ejection characteristics of the head have changed. Consequently, processing for calculating (updating) the density correction coefficients is started under the following conditions, for example, apart from the time of manufacture (shipment) of the apparatus.

Namely, the processing is performed under any of conditions of: (a) an automatic checking device (sensor), which monitors the print result, judges that a non-uniformity streak has occurred in the printed image; (b) a human observer judges that a non-uniformity streak has occurred in the printed image upon looking at the printed image, and performs a prescribed operation (such as inputting a command to start the updating process); and (c) a previously established update timing has been reached (the update timing can be set and judged by means of time management based on a timer, or the like, or operational record management based on a print counter).

When calculating the density correction coefficients, firstly, a test pattern (a previously determined print pattern) for ascertaining the ejection characteristics of the head is printed (step S11). The test pattern for obtaining the information on the depositing position and the test pattern for obtaining the information on the ejection failure nozzle can be different or the same to each other.

Thereupon, the deposition error data, in other words, the actual depositing positions of the deposited dots formed by the droplets ejected from the nozzles and the ejection failure nozzle information (the position of the ejection failure nozzle), are measured from the print results of the test pattern (step S12).

For this measurement of the deposition error data and determination of the ejection failure nozzle, it is possible to use an image reading device using an image sensor (imaging element) (including a signal processing device for processing the captured image signal). The depositing positions of the actual deposited droplets are measured from the image data thus read in, and information on the depositing position error is obtained on the basis of the difference with respect to the ideal depositing positions (i.e., ideal depositing positions at which the ejected droplets are intended to be deposited in the case where there are no ejection abnormalities or the like). Furthermore, apart from the depositing position information, the optical density of the droplet depositing points is also measured and nozzles that are incapable of performing droplet ejection are detected as “ejection failure nozzles”. An expression “depositing error data” is used to describe holistically various information (for example, actual depositing position information, depositing position error information, and optical density information) that can be obtained from the test pattern reading, and the information that identifies the position of the ejection failure nozzle is referred to as “ejection failure nozzle information”.

Next, using the ejection failure nozzle information obtained as described above, the information to use in calculating the density correction coefficient is decided and selected from the depositing position ion error data (step S13). In other words, the positional information corresponding to the ejection failure nozzle is excluded from the calculation (the deposition error data for the ejection failure nozzle is not used).

The deposition error data selected at step S13 is then used to derive a density correction coefficient in accordance with the equation (24) (step S14). In the present embodiment, since the correction coefficient takes account of the effects of the ejection failure nozzle, then in order to distinguish it from the correction coefficient in the related art, the term “density correction and ejection failure correction coefficient” is used in the flowchart in FIG. 5.

The information relating to the density correction and ejection failure correction coefficient derived in this way is stored in a rewriteable storage device, such as an EEPROM, and subsequently, the most recent correction coefficient is used.

In the case of a nozzle suffering ejection failure, it may in principle be impossible to obtain deposition error data for that nozzle; however, since an ejection failure may occur over the passage of time, then if there is a time difference between the timing at which the deposition error data is acquired and the timing at which the ejection failure information is acquired, then deposition error data relating to the ejection failure nozzle may exist. Under these circumstances, the deposition error data corresponding to the ejection failure nozzle is not used in the calculation.

Consequently, for example, in a case where a nozzle suffering ejection failure has occurred over time after deposition error data has been acquired, it is possible to achieve image correction which is consistent with the occurrence of the ejection failure nozzle by recalculating the density correction coefficient while excluding the positional information of the ejection failure nozzle from the calculation, without having to acquire deposition error data again.

Since it is relatively easy to acquire information about ejection failures in a recording head, compared to measuring the information on the depositing positions of the respective nozzles, then the acquisition frequency of the ejection failure information can be made higher than the acquisition frequency of the depositing position information. In cases such as these, by recalculating the density correction coefficient using the most recent information relating to ejection failure nozzles, then it is possible to adapt appropriately to the occurrence of nozzles suffering ejection failure and hence more suitable image correction can be achieved.

### Processing Sequence for Outputting Image in Inkjet Recording Apparatus

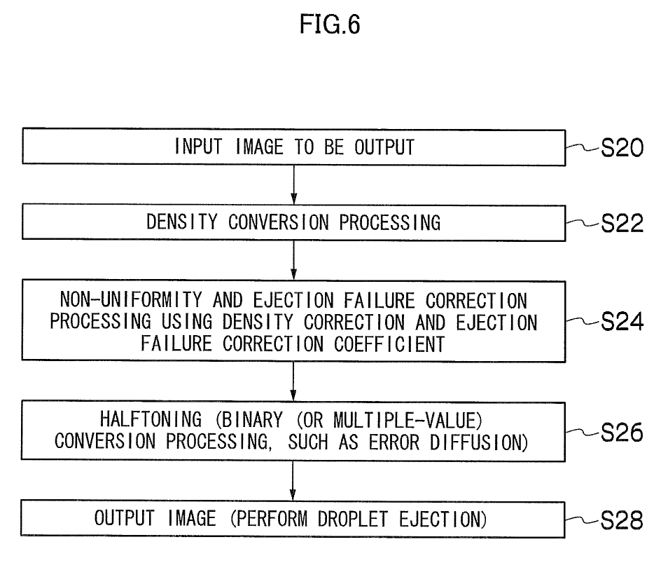

FIG. 6 shows a flowchart of a procedure for outputting an image. This procedure is followed every time when outputting image. When outputting (printing) an image, firstly the data of the image to be outputted (image to be printed) is input (step S20). There are no particular restrictions on the data format of the input image, but 24-bit color RGB data is input, for example. Density conversion processing based on a look-up table is carried out on this input image (step S22), thereby converting the input image into density data D(i,j) corresponding to the ink colors of the printers. Here, (i,j) indicates the position of a pixel, and hence the density data is assigned to respective pixels.

In this case, for the sake of explanation it is supposed that the image resolution of the input image matches the image resolution (nozzle resolution) of the printer. If the image resolution of the input image does not match the image resolution (nozzle resolution) of the printer, then pixel number conversion processing is carried out on the input image, in accordance with the resolution of the printer.

The density conversion processing in step S22 uses a general process, which includes under-color removal (UCR) processing, light ink distribution processing in the case of a system which uses light inks (light-colored inks of the same color), and so on.

For example, in the case of the printer having a three-ink composition comprising cyan (C), magenta (M) and yellow (Y), the image is converted into density data D(i, j) for each of the CMY inks. Alternatively, in the case of the printer having a system which also uses other inks, such as black (K), light cyan (LC), and light magenta (LM) in addition to the three inks of CMY, then the image is converted into density data D(i, j) for each of the inks including these additional ink colors.

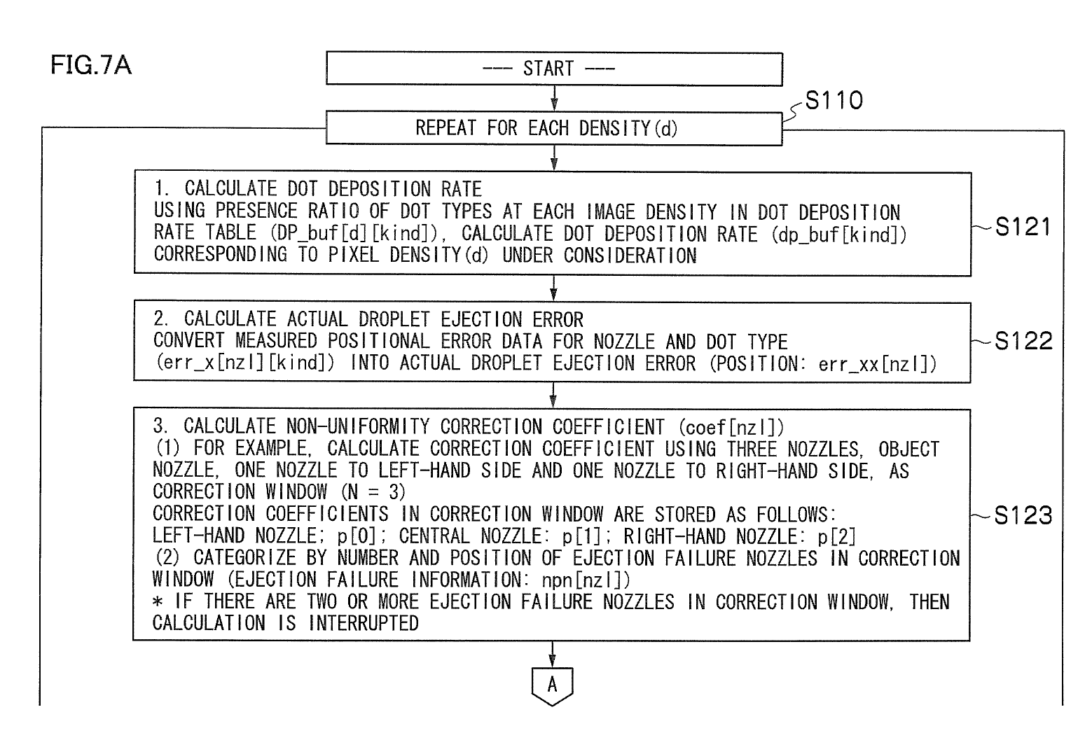

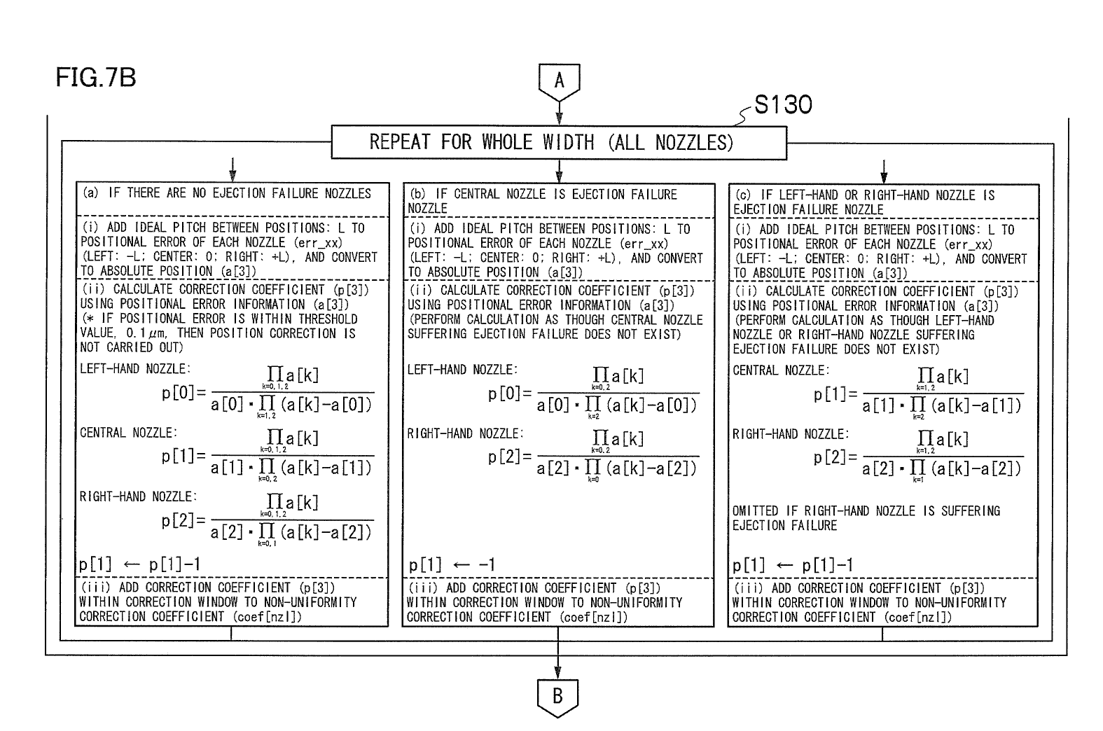

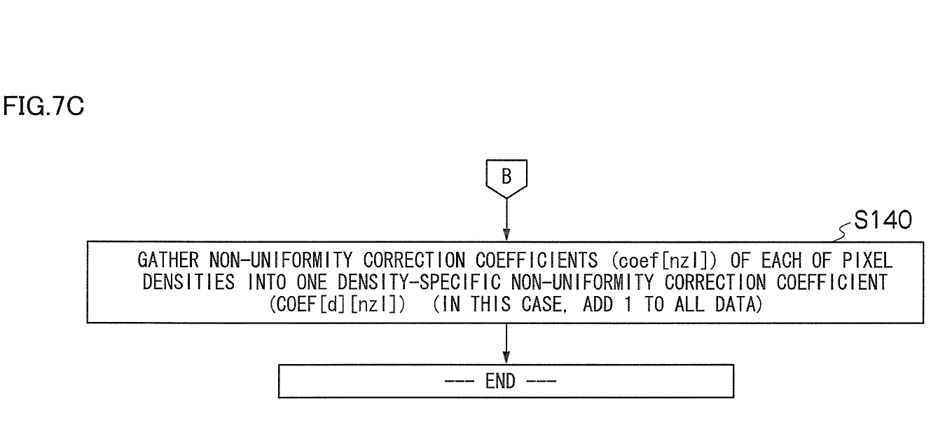

Next, non-uniformity correction processing in use of the density correction and ejection failure correction coefficients is carried out with respect to the density data D(i, j) obtained by the density conversion processing (step S24). The correction processing is described in detail with reference to FIGS. 7A to 9 below. The corrected density data D′(i,j) is thus obtained.

Thereupon, by applying a half-toning process to the corrected density data D′(i, j) (step S26 in FIG. 6), the data is converted into dot on/off signals (in binary data), or alternatively, if the dot sizes are variable, then the data is converted into multiple-value data signals including the size types (selection of dot size). There are no particular restrictions on the half-toning method used, and a commonly known binarizing (or multiple-value converting) technique, such as error diffusion, dithering, or the like, may be used.

Droplet ejection is performed by each nozzle on the basis of the binary (multiple-value) signal thus obtained, thereby outputting (recording) an image (step S28). In other words, ink ejection (droplet ejection) data for each nozzle is generated on the basis of the binary (multiple-value) data obtained by the halftoning process (step S26), and this data is used to control the ejection operation. Thereby, density non-uniformities are suppressed and images of high quality can be formed.

### Specific Embodiment of Method of Calculating Density Correction and Ejection Failure Correction Coefficients

FIGS. 7A, 7B and 7C show a flowchart of the calculation of a density correction and ejection failure correction coefficient according to an embodiment. Here, an example is described in which correction coefficients at respective pixel densities are calculated in order to determine correction coefficients corresponding to the pixel densities.

In the flowchart shown in FIGS. 7A to 7C, processing for calculating correction coefficients relating to respective densities (step S110) is repeated at a prescribed step size (for example, in steps of “0.5”) in the image density range of “0.0 to 1.0”.

Firstly, the dot deposition rate is calculated in respect of the density(d) that is under consideration (step S121). More specifically, the dot deposition rate (dp_buf[kind]) corresponding to the pixel density(d) under consideration is calculated by using a dot deposition table showing the presence ratio of dot types at the respective image densities. The dot deposition rate table (DP_buf[d][kind]) is a table based on the variables, density [d] and dot type [kind].

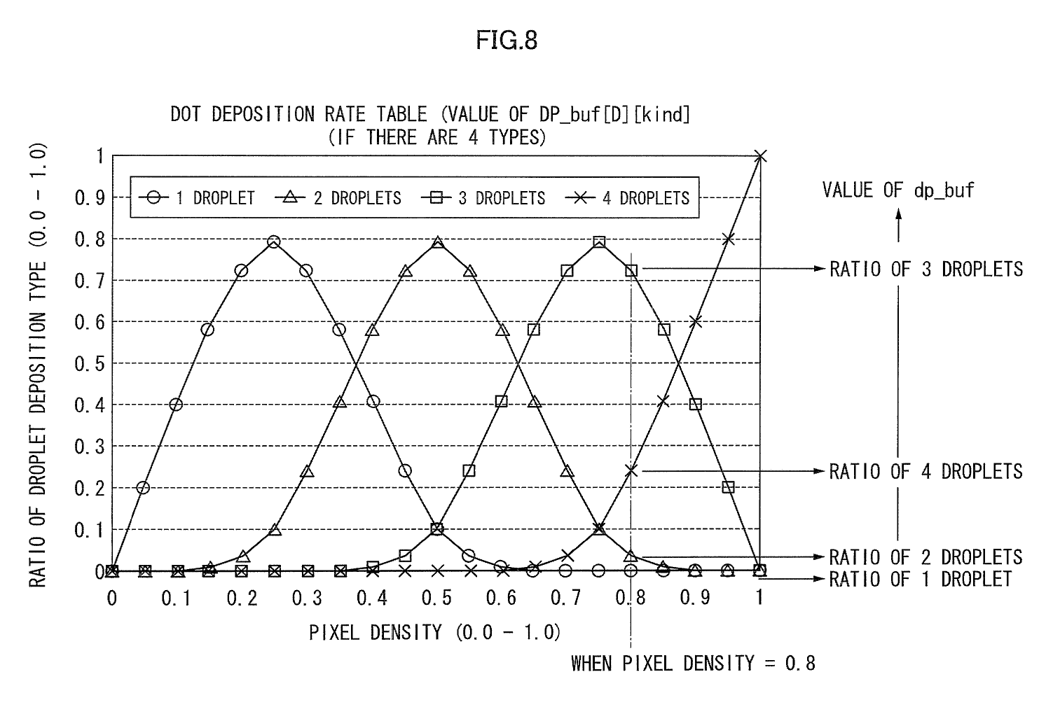

FIG. 8 shows an example of a dot deposition rate table (DP_buf[d][kind]). FIG. 8 shows an example where there are four types of dot (kind={1,2,3,4}). In FIG. 8, the horizontal axis represents the pixel density and the vertical axis represents the dot deposition type (dot type) ratio. Looking at the ratio between different dot types when the pixel density=0.8, the ratio of “3 droplets” is highest at about 0.72, the ratio of “4 droplets” is next, at about 0.24, the ratio of “2 droplets” is about 0.04 and the ratio of “1 droplet” is 0.0. In this way, the ratios of the respective dot types at a particular pixel density value are set as the dp_buf value.

The dot deposition rate table such as that shown in FIG. 8 is created and stored in advance. It is also possible to calculate the dot deposition rate table by interpolation for use as and when necessary.

After the dot deposition rate has been determined on the basis of the density under consideration as described above, the actual droplet ejection error is calculated (step S122 in FIG. 7A). More specifically, at step S122, calculation is carried out for each nozzle in order to convert the positional error data measurement values (err_x[nzl][kind]) for each type of dot, respectively into actual droplet ejection errors (position: err_xx[nzl]).

The component of the actual droplet ejection error (position: err_xx[nzl]) is calculated as follows:

$$err\_xx [ nzl ] = \frac{{\sum }_{kind} ( \begin{matrix}err\_x [ nzl ] [ kind ] \cdot dp\_buf [ kind ] \cdot \\ volume [ kind ]\end{matrix} )}{{\sum }_{kind} ( dp\_buf [ kind ] \cdot volume [ kind ] )} . \qquad ( 25 )$$

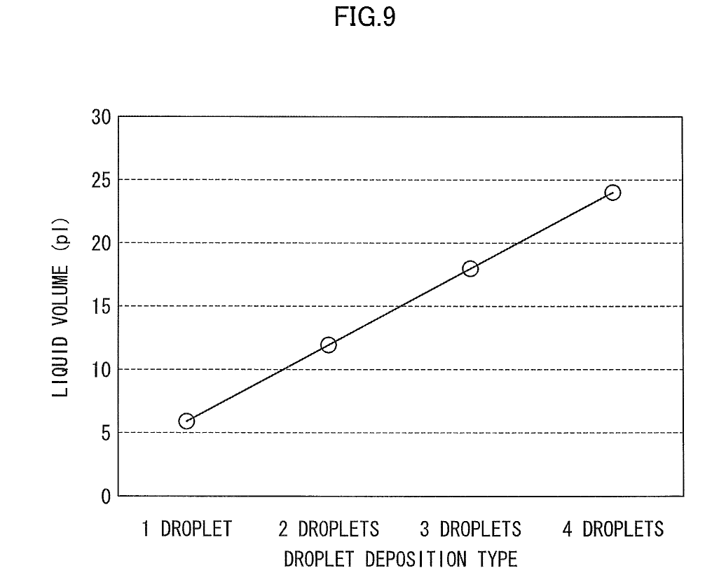

In other words, the “position: err_xx[nzl]” in the actual droplet ejection error is found by weighted averaging of the measurement values of the depositing position error, by weighting with the dot deposition rate (dp_buf[kind]) and the droplet ejection volume (volume[kind]). The table of droplet ejection volume (volume[kind]) is previously stored by measuring the liquid volumes of each dot type. FIG. 9 shows an example of a droplet ejection volume table.

After step S122 in FIG. 7A, the procedure advances to step S123 and the non-uniformity correction coefficient (coef[nzl]) is calculated. In order to make the description easier to understand, a simple concrete example will be described. For instance, a case is described in which a correction coefficient is calculated by taking three nozzles, namely, the nozzle that is the object of correction, one nozzle to the left-hand side of the object nozzle, and one nozzle to the right-hand side of the object nozzle, as the correction window (N=3). In this case, the correction coefficient of the left-hand nozzle in the correction window is stored as p[0], the correction coefficient of the central nozzle is stored as p[1] and the correction coefficient of the right-hand nozzle is stored as p[2].

Furthermore, in the calculation step, cases are categorized in terms of the number and positions of ejection failure nozzles in the correction window, on the basis of the ejection failure information (npn[nzl]) of the head (see FIG. 7B). In the present example, if ejection failure nozzles are present at two or more places in the correction window, then the calculation is halted. FIG. 7B shows a concrete example of calculation.

The calculation described below is repeated for all of the nozzles of the head (step S130).

Firstly, the correction window that is the object of calculation is specified and categorized into one of the following three patterns, depending on the number and position of ejection failure nozzles in the correction window. The three pattern categories are: (a) cases where there are no ejection failure nozzles; (b) cases where the central nozzle is suffering ejection failure; and (c) cases where the left or right-hand nozzle is suffering ejection failure. The routine switches to the appropriate processing, accordingly.

(a) If there is no ejection failure nozzle, then the following processing is carried out.

The ideal pitch between positions: L is added to the positional error of the nozzles (left: −L; central: 0; right:+L) to convert to an absolute position (a[3]). In other words, the following calculations are carried out:

Left-hand nozzle: a[0]←err_xx[nzl−1]−L; (26)

Central nozzle: a[1]←err_xx[nzl]+0; and (27)

Right-hand nozzle: a[2]←err_xx[nzl+1]+L. (28)

The correction coefficient (p[3]) is then calculated using the positional error information (a[3]). This calculation can be made by directly employing the method in the related art stated in the equation (22). Here, to simplify the notation, the three suffixes [0], [1], [2] which indicate the nozzle position within the correction window are represented jointly as [3].

If the positional error indicated by the positional error information (a[3]) is within a prescribed threshold value (for example, 0.1 μm), then it is decided that correction is substantially unnecessary and therefore positional correction is not carried out. The threshold value used as a criterion for judging whether or not to carry out correction is specified from the viewpoint of the acceptable error range.

The correction coefficients of the respective nozzles in the correction window are calculated as follows:

$$\begin{matrix}Left \text{-} hand nozzle \text{:} p [ 0 ] = \frac{{\prod }_{k = 0 , 1 , 2} a [ k ]}{a [ 0 ] \cdot {\prod }_{k = 1 , 2} ( a [ k ] - a [ 0 ] )} ; & ( 29 ) \\ Central nozzle \text{:} p [ 1 ] = \frac{{\prod }_{k = 0 , 1 , 2} a [ k ]}{a [ 1 ] \cdot {\prod }_{k = 0 , 2} ( a [ k ] - a [ 1 ] )} ; and & ( 30 ) \\ Right \text{-} hand nozzle \text{:} p [ 2 ] = \frac{{\prod }_{k = 0 , 1 , 2} a [ k ]}{a [ 2 ] \cdot {\prod }_{k = 0 , 1} ( a [ k ] - a [ 2 ] )} . & ( 31 )\end{matrix}$$

Moreover, a decrement of 1 is applied to the central nozzle (p[1]). More specifically, the following calculation is performed:

p[1]←+p[1]−1. (32)

Next, the correction coefficients in the correction window as determined above are added to the non-uniformity correction coefficient (coef[nzl]). More specifically, the following calculation is performed:

coef[nzl−1] coef[nzl−1]+p[0]; (33)

coef[nzl]←coef[nzl]+p[1]; and (34)

coef[nzl+1]←coef[nzl+1]+p[2]. (35)

(b) If the central nozzle is an ejection failure nozzle, then the following processing is carried out.

The ideal pitch between positions: L is added to the positional error of the nozzles (left: −L; central: 0; right:+L) to convert to an absolute position (a[3]) (see the equations (26) to (28)). The correction coefficient (p[3]) is then calculated using the positional error information (a[3]). This calculation is carried out by excluding the ejection failure nozzle, as indicated in the equation (24). In other words, the calculation is made as though the central nozzle that is suffering ejection failure does not exist.

The correction coefficients of the respective nozzles in the correction window are calculated as follows:

$$\begin{matrix}Left \text{-} hand nozzle \text{:} p [ 0 ] = \frac{{\prod }_{k = 0 , 2} a [ k ]}{a [ 0 ] \cdot {\prod }_{k = 2} ( a [ k ] - a [ 0 ] )} ; and & ( 36 ) \\ Right \text{-} hand nozzle \text{:} p [ 2 ] = \frac{{\prod }_{k = 0 , 2} a [ k ]}{a [ 2 ] \cdot {\prod }_{k = 0} ( a [ k ] - a [ 2 ] )} . & ( 37 )\end{matrix}$$

Moreover, −1 is substituted for the central nozzle (p[1]):

p[1]←1. (38)

Next, the correction coefficients in the correction window as determined above are added to the non-uniformity correction coefficient (coef[nzl]). More specifically, the following calculation is performed:

coef[nzl−1]←coef[nzl−1]+p[0]; (39)

coef[nzl]←coef[nzl]+p[1] ; and (40)

coef[nzl+1]←coef[nzl+1]+p[2]. (41)

(c) If the left right-hand nozzle or the right-hand nozzle is an ejection failure nozzle, then the following processing is carried out.

The ideal pitch between positions: L is added to the positional error of the nozzles (left: −L; central: 0; right:+L) to convert to an absolute position (a[3]) (see the equations (26) to (28)). The correction coefficient (p[3]) is then calculated using the positional error information (a[3]). This calculation is carried out by excluding the ejection failure nozzle, as indicated in the equation (24). In other words, the calculation is made as though the left right-hand nozzle or the right-hand nozzle that is suffering ejection failure does not exist.

If the left-hand nozzle is suffering ejection failure, then the correction coefficients of the respective nozzles in the correction window are calculated as follows:

$$\begin{matrix}Central nozzle \text{:} p [ 1 ] = \frac{{\prod }_{k = 1 , 2} a [ k ]}{a [ 1 ] \cdot {\prod }_{k = 2} ( a [ k ] - a [ 1 ] )} ; and & ( 42 ) \\ Right \text{-} hand nozzle \text{:} p [ 2 ] = \frac{{\prod }_{k = 1 , 2} a [ k ]}{a [ 2 ] \cdot {\prod }_{k = 1} ( a [ k ] - a [ 2 ] )} . & ( 43 )\end{matrix}$$

Moreover, a decrement of 1 is applied to the central nozzle (p[1]):

p[1]←+p[1]−1. (44)

Further, 0 is substituted for the left-hand nozzle (p[0]):

p[0]←0. (45)

If the right-hand nozzle is suffering ejection failure, then the correction coefficients of the respective nozzles in the correction window are calculated as follows:

$$\begin{matrix}Left \text{-} hand nozzle \text{:} p [ 0 ] = \frac{{\prod }_{k = 0 , 2} a [ k ]}{a [ 0 ] \cdot {\prod }_{k = 2} ( a [ k ] - a [ 0 ] )} ; and & ( 46 ) \\ Central nozzle \text{:} p [ 1 ] = \frac{{\prod }_{k = 1 , 2} a [ k ]}{a [ 1 ] \cdot {\prod }_{k = 2} ( a [ k ] - a [ 1 ] )} . & ( 47 )\end{matrix}$$

Moreover, a decrement of 1 is applied to the central nozzle (p[1]):

p[1]←p[1]−1. (48)

Further, 0 is substituted for the right-hand nozzle (p[2]):

p[2]←0. (49)

Next, the correction coefficients in the correction window as determined above are added to the non-uniformity correction coefficient (coef[nzl]). More specifically, the following calculation is performed:

coef[nzl−1]←coef[nzl−1]+p[0]; (50)

coef[nzl]←coef[nzl]+p[1] ; and (51)

coef[nzl+1]←coef[nzl+1]+p[2]. (52)

The calculation processing described above is repeated in respect of all of the nozzles in the head (step S130).

After carrying out similar processing successively in respect of the respective pixel densities, the non-uniformity correction coefficients (coef[nzl]) of each of the pixel densities are gathered into one density-specific non-uniformity correction coefficient (COEF[d][nzl]) (step S140). In this case, 1 is added to all of the data. More specifically, the non-uniformity correction coefficient (coef[nzl]) for a density of d is rewritten by adding 1 to the density-specific non-uniformity correction coefficient (COEF[d][nzl]) in respect of all of the nozzles: nzl as follows:

COEF[d][nzl]←coef[nzl]+1. (53)

When the processing described above has been executed, the current calculation process is terminated.

### About Processing of Image Data

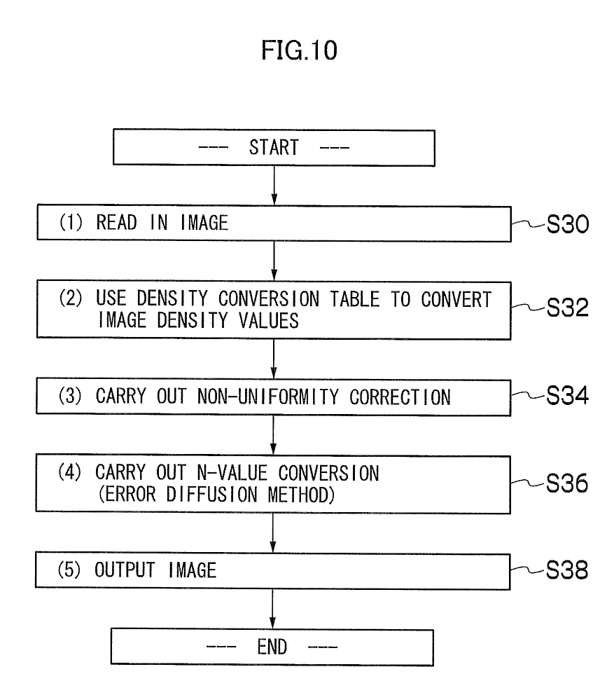

FIG. 10 shows a flowchart of the processing of image data. As shown in FIG. 6 as well, firstly, the image data is read in (step S30), and the image density values of this image data are converted using a density conversion table (step S32). This density data is then subjected to non-uniformity correction processing (step S34), and the corrected density data is then converted to data of N values (in the present embodiment, an example based on error diffusion is explained below) (step S36). Droplet ejection is then carried out on the basis of the data of N values thus obtained (dot data) (step S38).

### Description of Non-Uniformity Correction Procedure Flowchart

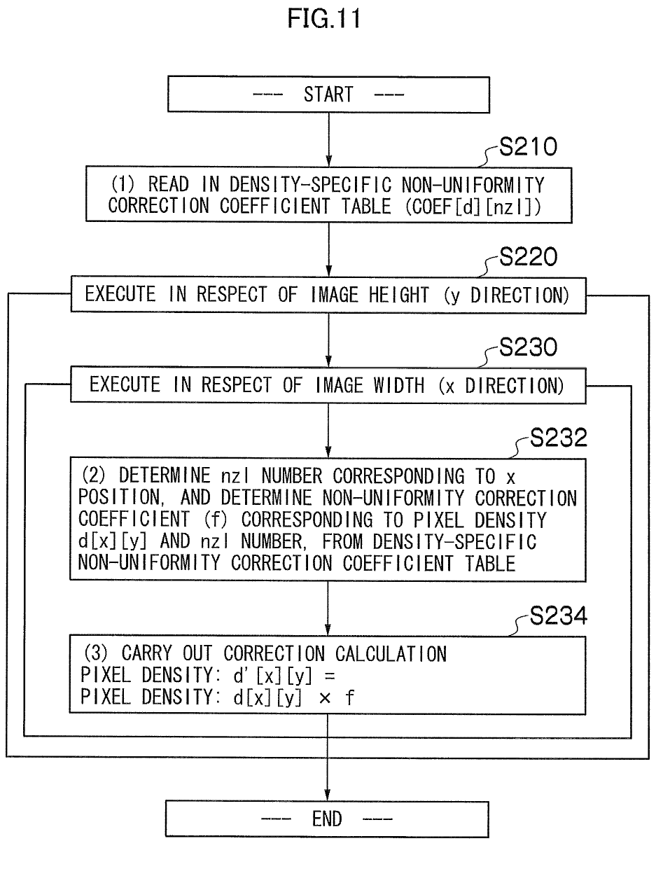

FIG. 11 shows a detailed example of the non-uniformity correction processing (step S34) in FIG. 10. FIG. 11 shows a flowchart of a non-uniformity correction procedure. When this processing is started, firstly, the density-specific non-uniformity correction table is read in (step S210). Thereupon, the processing in step S230 described below is repeated for the whole range while successively changing the position that is the object of calculation (y value) in the height direction (y direction) of the image (step S220).

More specifically, at step S230, the position (x value) that is the object of calculation is specified in the breadthways direction of the image (x direction) at the y value that is the object of calculation, the nozzle number (nzl number) corresponding to this x position is determined, and the non-uniformity correction coefficient (f) corresponding to the image density d[x][y] and the nzl number is found from the density-specific non-uniformity correction coefficient table (step S232). This non-uniformity correction coefficient (f) is then used to carry out correctional calculation as follows (step S234):

Pixel density: d′[x][y]=Image density: d[x][y]×f. (54)

The steps S232 to S234 described above are repeated for the whole width of the image while successively changing the x position in the image width direction (x direction) (step S230).

When the correctional calculation described above has been completed for all of the image positions [x][y], the present processing terminates.

### Description of Error Diffusion Method

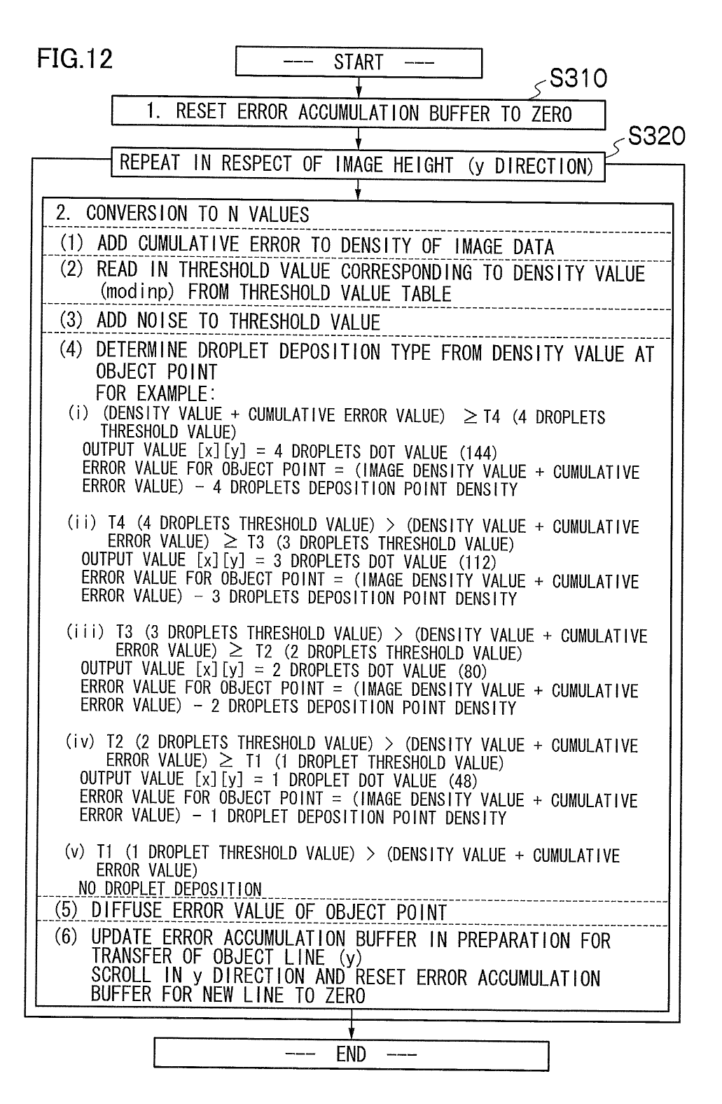

FIG. 12 shows a flowchart of an error diffusion method which is carried out in the N value conversion processing (step S36) in FIG. 10.

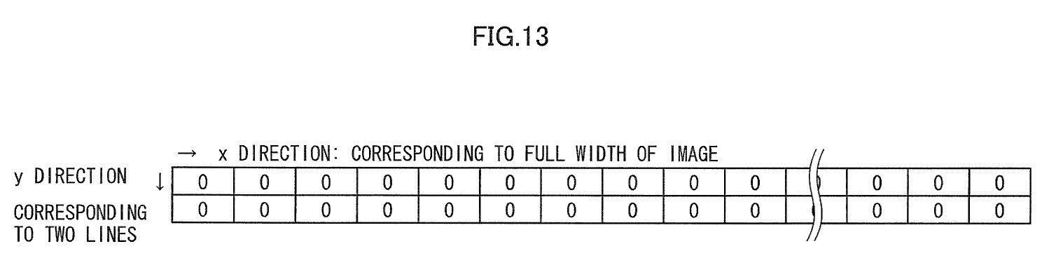

When this processing is started, firstly, the error accumulation buffer is reset to zero (step S310). FIG. 13 shows a conceptual diagram of an error accumulation buffer. As shown in FIG. 13, the error accumulation buffer has data storage cells corresponding to the respective positions of the entire width of the image in the x direction, and is capable of storing data for two lines in the y direction. At step S310 in FIG. 12, the data of all of the cells is reset to zero, as shown in FIG. 13.

Thereupon, the processing described below is repeated for the whole range while successively changing the position (y value) that is the object of calculation in the height direction (y direction) of the image (step S320 in FIG. 12).

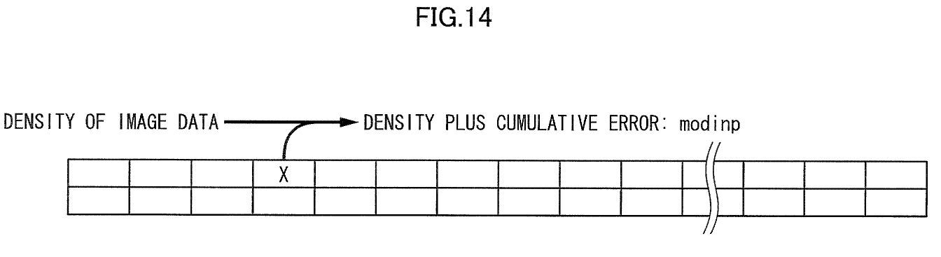

More specifically, N value conversion processing is carried out in a raster sequence for each x position belonging to the line of the y value relating to the object of calculation. In the N value conversion procedure, firstly, the cumulative error value is added to the density of the image data in respect of the x position currently under consideration in the breadthways direction of the image. FIG. 14 shows an explanatory diagram of this. The cumulative error value for the x position under consideration in the error accumulation buffer is added to the image data density, and this density plus cumulative error value is taken as a density value “modinp”.

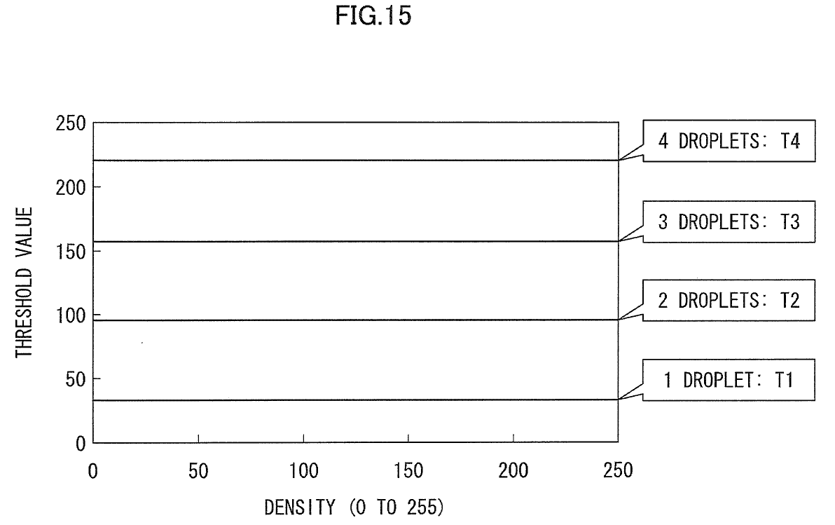

Thereupon, the threshold value corresponding to the density value (modinp) is read in from a threshold value table for N value conversion. FIG. 15 shows an example of the threshold value table. The threshold value table shown in FIG. 15 relates to a case where four types of dot depositions are used (i.e., data is converted to five values), and the respective threshold values for “1 droplet” to “4 droplets” are set to T1 to T4 for the dot types.

After adding a suitable noise to the threshold value read in from the threshold value table, the type of droplet ejection is determined from the density value at the object point. In the case of the present example, the type of droplet ejection is determined as described below from the value “density value+cumulative error value” and the relative magnitudes of T1, T2, T3 and T4 (see FIG. 12).

(i) If the value of “density value+cumulative error value” is equal to or greater than T4

If the value of “density value+cumulative error value” is equal to or greater than T4, then the output image (droplet depositing point density) at the pixel position [x] [y] is specified as a “4 droplets” dot value (e.g., a value of “144” in 8-bit data). The error value for the object point generated by the N value conversion process is the value given by subtracting the “4 droplets” depositing point density from the sum of “density value+cumulative error value”.

(ii) If the value of “density value+cumulative error value” is equal to or greater than T3 and less than T4

If the value of “density value+cumulative error value” is equal to or greater than T3 and less than T4, then the output image (droplet depositing point density) for the pixel position [x][y] is specified as a “3 droplets” dot value (e.g., it is set to “112”). The error value for the object point generated by the N value conversion process is the value given by subtracting the “3 droplets” depositing point density from the sum of “density value+cumulative error value”.

(iii) If the value of “density value+cumulative error value” is equal to or greater than T2 and less than T3

If the value of “density value+cumulative error value” is equal to or greater than T2 and less than T3, then the output image (droplet depositing point density) for the pixel position [x][y] is specified as a “2 droplets” dot value (e.g., it is set to “80”). The error value for the object point generated by the N value conversion process is the value given by subtracting the “2 droplets” depositing point density from the sum of “density value+cumulative error value”.

(iv) If the value of “density value+cumulative error value” is equal to or greater than T1 and less than T2

If the value of “density value+cumulative error value” is equal to or greater than T1 and less than T2, then the output image (droplet depositing point density) for the pixel position [x][y] is specified as a “1 droplet” dot value (e.g., it is set to “48”). The error value for the object point generated by the N value conversion process is the value given by subtracting the “1 droplet” depositing point density from the sum of “density value+cumulative error value”.

(v) If the value of “density value+cumulative error value” is less than T1

If the value of “density value+cumulative error value” is less than T1, then no dot deposition (a droplet depositing point density of 0) is set for that pixel position [x] [y]. The error value for the object point generated by the N value conversion process is the actual sum of “density value+cumulative error value” itself.

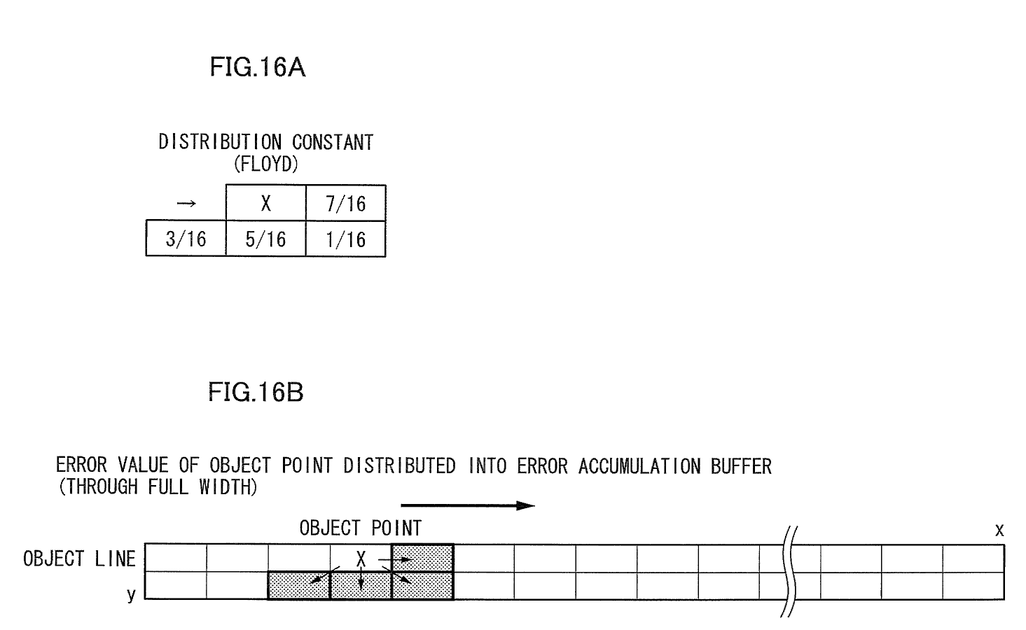

Thereupon, processing is carried out whereby the error value for the object point generated by the N value conversions in (i) to (v) described above is diffused into the unprocessed pixels that are adjacent to the object point. FIGS. 16A and 16B show one example of a method of diffusing error values. In FIGS. 16A and 16B, the error value generated at the object point [x] is distributed respectively using the ratios (distribution constants) indicated in FIG. 16A, into the four adjacent positions that have not yet been processed.

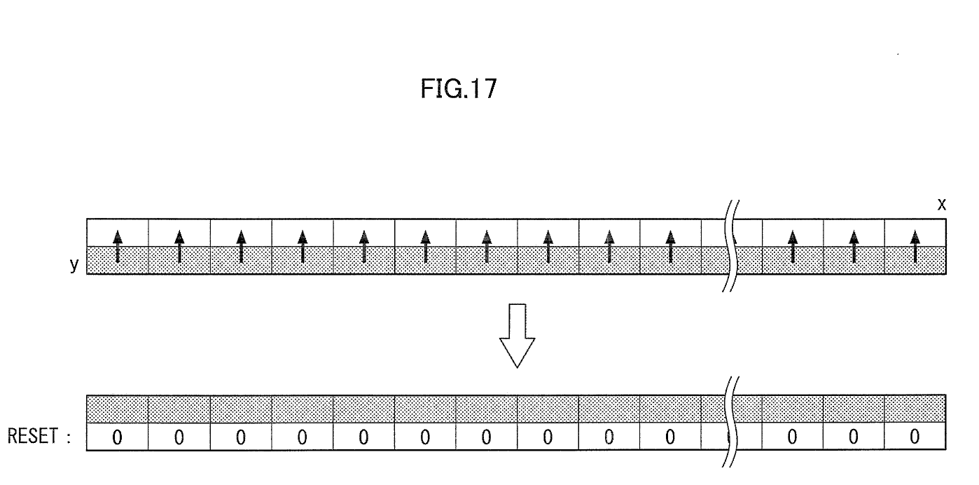

After completing the N value conversion processing described above in respect of all of the x positions belonging to the object line, the object line (y) is changed. In this case, the error accumulation buffer is updated in order to prepare for the shift in the object line (y). More specifically, as shown in FIG. 17, the error accumulation buffer is scrolled in the y direction and the accumulation buffer relating to the new line is reset to zero.

In this way, the processing described above is repeated for all of the lines in the height (y direction) of the image, and when the dot deposition type has been determined for all of the pixels, the procedure terminates.

### Composition of Inkjet Recording Apparatus

Next, an inkjet recording apparatus is described which forms an image recording apparatus according to an embodiment of the present invention. The inkjet recording apparatus has the density non-uniformity correction function described above.

Next, an inkjet recording apparatus is described which forms an image recording apparatus according to an embodiment of the present invention. The inkjet recording apparatus has the density non-uniformity correction function described above.

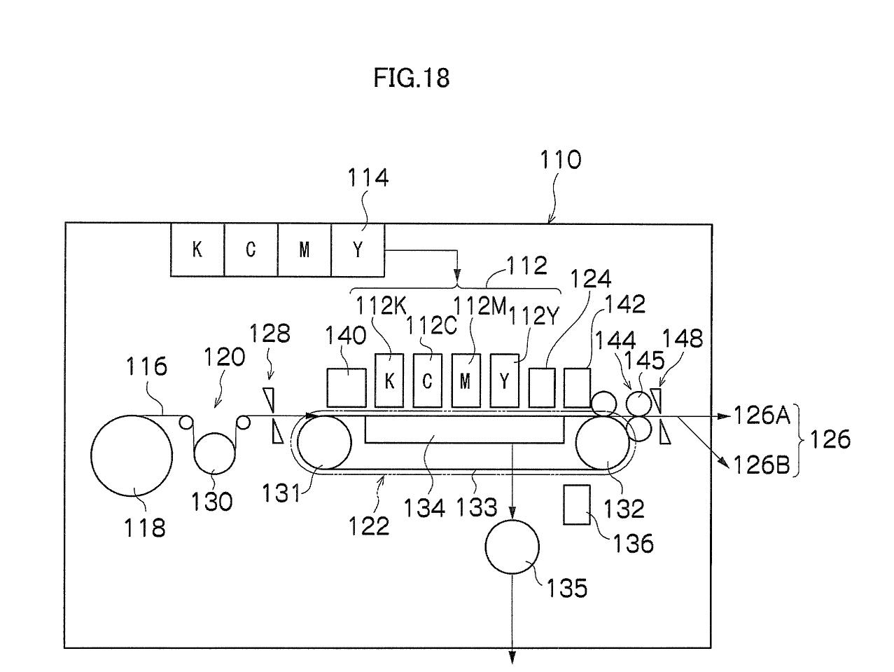

FIG. 18 is a general schematic drawing of an inkjet recording apparatus 110, which forms one embodiment of an image recording apparatus according to the present invention. As shown in FIG. 18, the inkjet recording apparatus 110 comprises: a print unit 112 having a plurality of inkjet recording heads (hereinafter referred to as heads) 112K, 112C, 112M, and 112Y provided for ink colors of black (K), cyan (C), magenta (M), and yellow (Y), respectively; an ink storing and loading unit 114 for storing inks to be supplied to the heads 112K, 112C, 112M and 112Y; a paper supply unit 118 for supplying recording paper 116 forming a recording medium; a decurling unit 120 for removing curl in the recording paper 116; a belt conveyance unit 122, disposed facing the nozzle face (ink ejection face) of the print unit 112, for conveying the recording paper 116 while keeping the recording paper 116 flat; a print determination unit 124 for reading the printed result produced by the print unit 112; and a paper output unit 126 for outputting the recorded recording paper (printed matter) to the exterior.

The ink storing and loading unit 114 has ink tanks for storing the inks of K, C, M and Y to be supplied to the heads 112K, 112C, 112M, and 112Y, and the tanks are connected to the heads 112K, 112C, 112M, and 112Y by means of prescribed channels. The ink storing and loading unit 114 has a warning device (for example, a display device or an alarm sound generator) for warning when the remaining amount of any ink is low, and has a mechanism for preventing loading errors among the colors.

In FIG. 18, a magazine for rolled paper (continuous paper) is shown as an embodiment of the paper supply unit 118; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording media can be used, it is preferable that an information recording medium such as a bar code and a wireless tag containing information about the type of recording medium is attached to the magazine, and by reading the information contained in the information recording medium with a predetermined reading device, the type of recording medium to be used is automatically determined, and ink-droplet ejection is controlled so that the ink-droplets are ejected in an appropriate manner in accordance with the type of medium.

The recording paper 116 delivered from the paper supply unit 118 retains curl due to having been loaded in the magazine. In order to remove the curl, heat is applied to the recording paper 116 in the decurling unit 120 by a heating drum 130 in the direction opposite from the curl direction in the magazine. The heating temperature at this time is preferably controlled so that the recording paper 116 has a curl in which the surface on which the print is to be made is slightly round outward.

In the case of the configuration in which roll paper is used, a cutter (first cutter) 128 is provided as shown in FIG. 18, and the continuous paper is cut into a desired size by the cutter 128. When cut papers are used, the cutter 128 is not required.

The decurled and cut recording paper 116 is delivered to the belt conveyance unit 122. The belt conveyance unit 122 has a configuration in which an endless belt 133 is set around rollers 131 and 132 so that the portion of the endless belt 133 facing at least the nozzle face of the print unit 112 and the sensor face of the print determination unit 124 forms a horizontal plane (flat plane).

The belt 133 has a width that is greater than the width of the recording paper 116, and a plurality of suction apertures (not shown) are formed on the belt surface. A suction chamber 134 is disposed in a position facing the sensor surface of the print determination unit 124 and the nozzle surface of the print unit 112 on the interior side of the belt 133, which is set around the rollers 131 and 132, as shown in FIG. 18. The suction chamber 134 provides suction with a fan 135 to generate a negative pressure, and the recording paper 116 is held on the belt 133 by suction. In place of the suction system, an electrostatic attraction system can be employed.

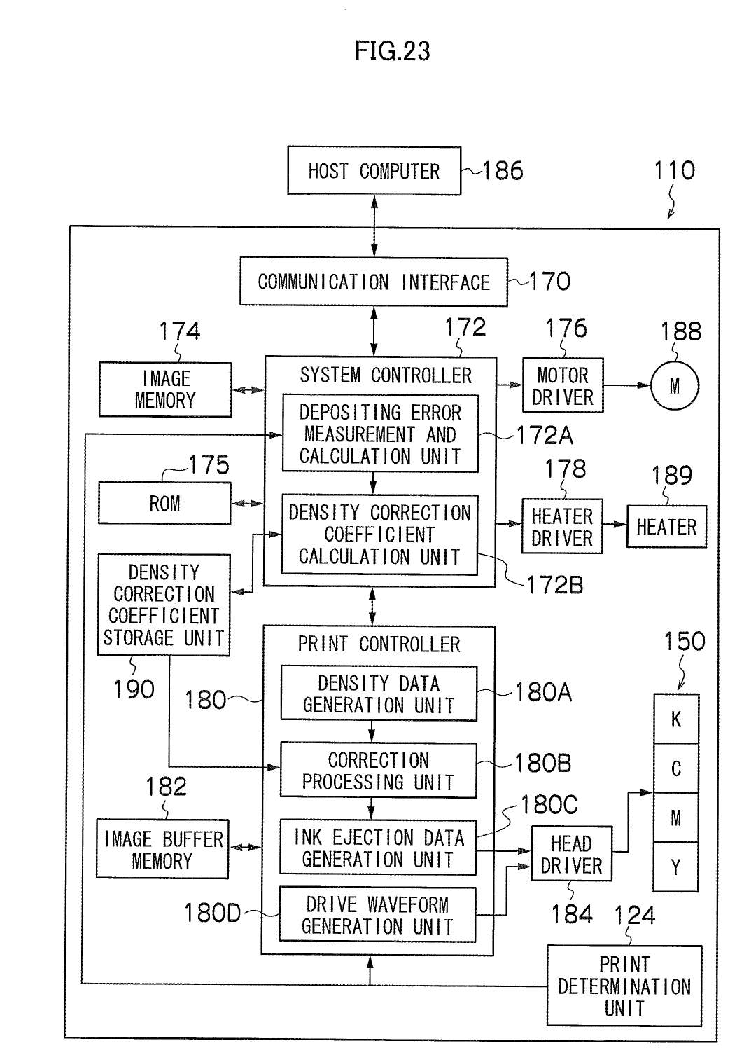

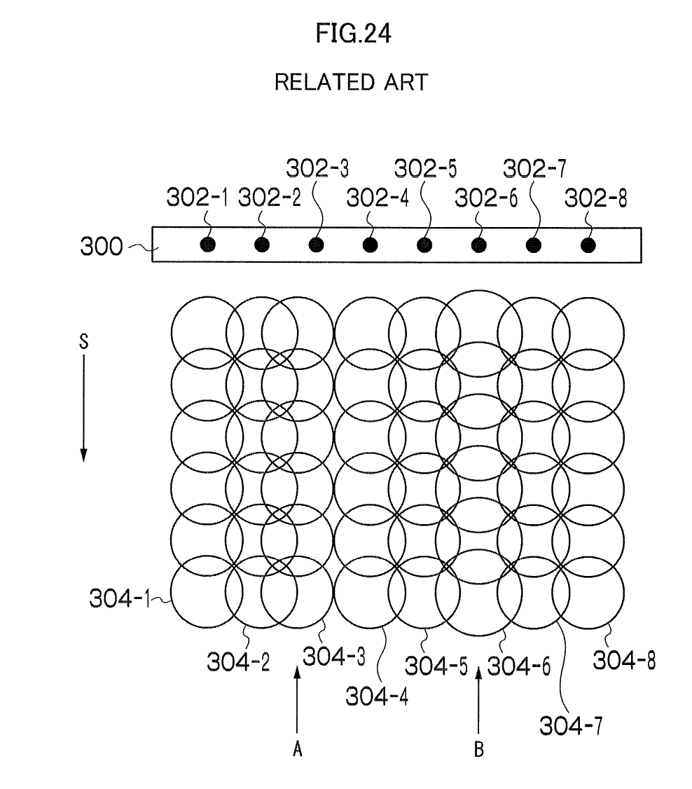

The belt 133 is driven in the clockwise direction in FIG. 18 by the motive force of a motor 188 (shown in FIG. 23) being transmitted to at least one of the rollers 131 and 132, which the belt 133 is set around, and the recording paper 116 held on the belt 133 is conveyed from left to right in FIG. 18.

Since ink adheres to the belt 133 when a marginless print job or the like is performed, a belt-cleaning unit 136 is disposed in a predetermined position (a suitable position outside the printing area) on the exterior side of the belt 133. Although the details of the configuration of the belt-cleaning unit 136 are not shown, embodiments thereof include a configuration in which the belt is nipped with cleaning rollers such as a brush roller and a water absorbent roller, an air blow configuration in which clean air is blown onto the belt 133, or a combination of these. In the case of the configuration in which the belt 133 is nipped with the cleaning rollers, it is preferable to make the line velocity of the cleaning rollers different than that of the belt 133 to improve the cleaning effect.

The inkjet recording apparatus may comprise a roller nip conveyance mechanism, instead of the belt conveyance unit 122. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 140 is disposed on the upstream side of the print unit 112 in the conveyance pathway formed by the belt conveyance unit 122. The heating fan 140 blows heated air onto the recording paper 116 to heat the recording paper 116 immediately before printing so that the ink deposited on the recording paper 116 dries more easily.

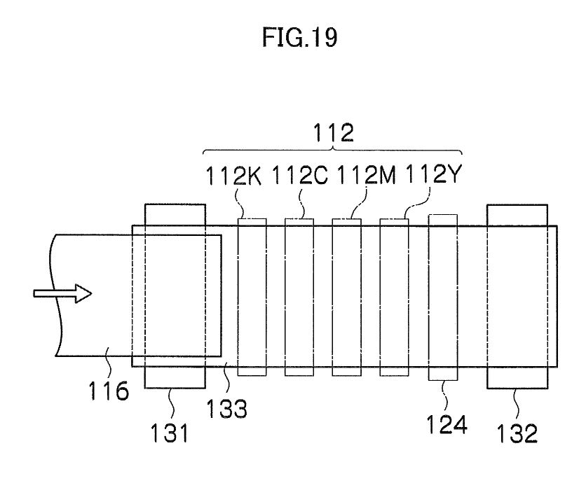

The heads 112K, 112C, 112M and 112Y of the print unit 112 are full line heads having a length corresponding to the maximum width of the recording paper 116 used with the inkjet recording apparatus 110, and comprising a plurality of nozzles for ejecting ink arranged on a nozzle face through a length exceeding at least one edge of the maximum-size recording medium (namely, the full width of the printable range) (see FIG. 19).

The print heads 112K, 112C, 112M and 112Y are arranged in this color order (black (K), cyan (C), magenta (M), yellow (Y)) from the upstream side in the feed direction of the recording paper 116, and these heads 112K, 112C, 112M and 112Y are fixed extending in a direction substantially perpendicular to the conveyance direction of the recording paper 116.

A color image can be formed on the recording paper 116 by ejecting inks of different colors from the heads 112K, 112C, 112M and 112Y, respectively, onto the recording paper 116 while the recording paper 116 is conveyed by the belt conveyance unit 122.

By adopting a configuration in which the full line heads 112K, 112C, 112M and 112Y having nozzle rows covering the full paper width are provided for the respective colors in this way, it is possible to record an image on the full surface of the recording paper 116 by performing just one operation of relatively moving the recording paper 116 and the print unit 112 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The print determination unit 124 shown in FIG. 18 has an image sensor (line sensor or area sensor) for capturing an image of the droplet ejection result of the print unit 112, and functions as a device to check the ejection characteristics, such as blockages, depositing position error, and the like, of the nozzles, on the basis of the image of ejected droplets read in by the image sensor. A test pattern or the target image printed by the print heads 112K, 112C, 112M, and 112Y of the respective colors is read in by the print determination unit 124, and the ejection performed by each head is determined. The ejection determination includes the presence of the ejection, measurement of the dot size, and measurement of the dot depositing position.

A post-drying unit 142 is disposed following the print determination unit 124. The post-drying unit 142 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 144 is disposed following the post-drying unit 142. The heating/pressurizing unit 144 is a device to control the glossiness of the image surface, and the image surface is pressed with a pressure roller 145 having a predetermined uneven surface shape while the image surface is heated, and the uneven shape is transferred to the image surface.

The printed matter generated in this manner is outputted from the paper output unit 126. The target print (i.e., the result of printing the target image) and the test print are preferably outputted separately. In the inkjet recording apparatus 110, a sorting device (not shown) is provided for switching the outputting pathways in order to sort the printed matter with the target print and the printed matter with the test print, and to send them to paper output units 126A and 126B, respectively. When the target print and the test print are simultaneously formed in parallel on the same large sheet of paper, the test print portion is cut and separated by a cutter (second cutter) 148. Although not shown in FIG. 18, the paper output unit 126A for the target prints is provided with a sorter for collecting prints according to print orders.

### Structure of Head

Next, the structure of the head is described. The heads 112K, 112C, 112M and 112Y of the respective ink colors have the same structure, and a reference numeral 150 is hereinafter designated to any of the heads.

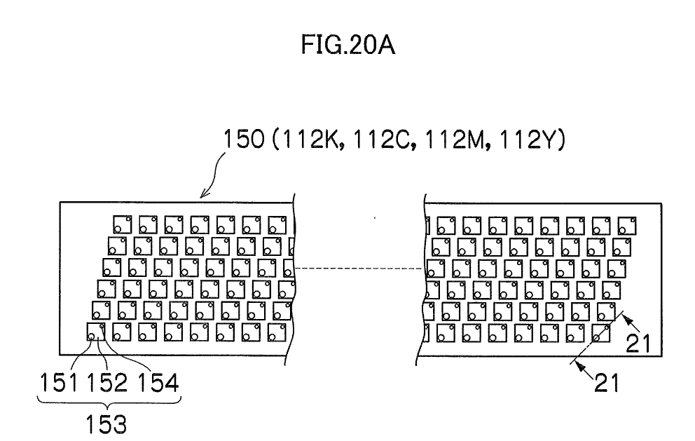

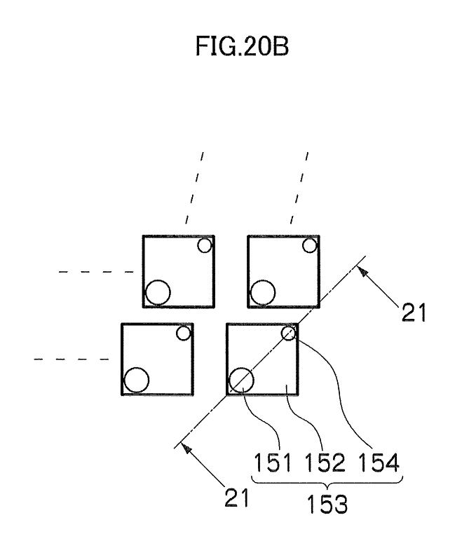

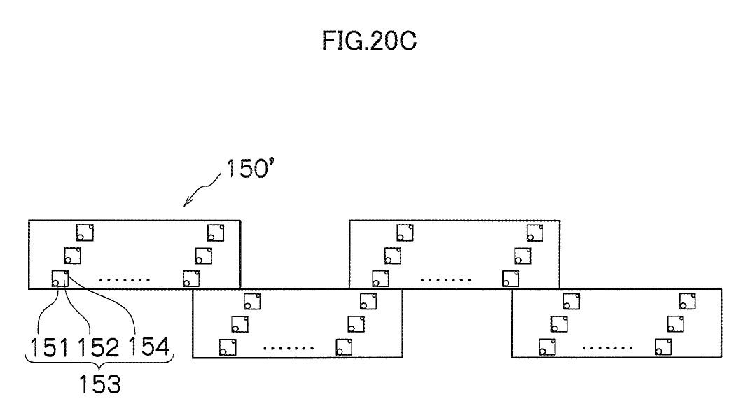

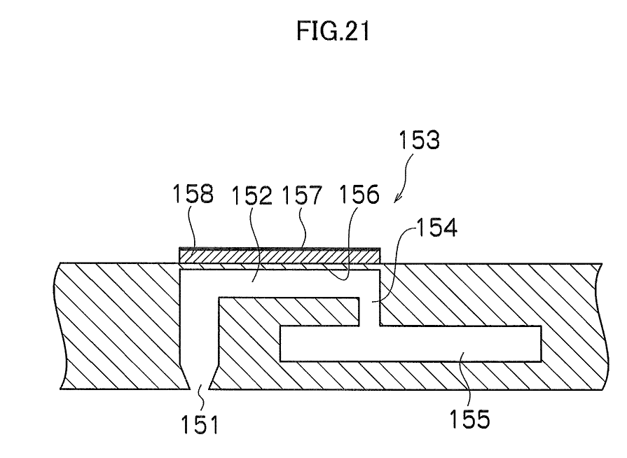

FIG. 20A is a perspective plan view showing an embodiment of the configuration of the head 150, FIG. 20B is an enlarged view of a portion thereof, FIG. 20C is a perspective plan view showing another embodiment of the configuration of the head 150, and FIG. 21 is a cross-sectional view taken along the line 21-21 in FIGS. 20A and 20B, showing the inner structure of a droplet ejection element (an ink chamber unit for one nozzle 151) for one channel constituting a recording element unit.

The nozzle pitch in the head 150 should be minimized in order to maximize the resolution of the dots printed on the surface of the recording paper 116. As shown in FIGS. 20A and 20B, the head 150 according to the present embodiment has a structure in which a plurality of ink chamber units (droplet ejection elements) 153, each comprising a nozzle 151 forming an ink ejection port, a pressure chamber 152 corresponding to the nozzle 151, and the like, are disposed two-dimensionally in the form of a staggered matrix, and hence the effective nozzle interval (the projected nozzle pitch) as projected (orthogonal projection) in the lengthwise direction of the head (the direction perpendicular to the paper conveyance direction) is reduced and high nozzle density is achieved.

The mode of forming one or more nozzle rows through a length corresponding to the entire width of the recording paper 116 in a direction substantially perpendicular to the conveyance direction of the recording paper 116 is not limited to the embodiment described above. For example, instead of the configuration in FIG. 20A, as shown in FIG. 20C, a line head having nozzle rows of a length corresponding to the entire width of the recording paper 116 can be formed by arranging and combining, in a staggered matrix, short head modules 150′ each having a plurality of nozzles 151 arrayed in a two-dimensional fashion.

As shown in FIGS. 20A and 20B, the planar shape of the pressure chamber 152 provided corresponding to each nozzle 151 is substantially a square shape, and an outlet port to the nozzle 151 is provided at one of the ends of the diagonal line of the planar shape, while an inlet port (supply port) 154 for supplying ink is provided at the other end thereof. The shape of the pressure chamber 152 is not limited to that of the present embodiment and various modes are possible in which the planar shape is a quadrilateral shape (rhombic shape, rectangular shape, or the like), a pentagonal shape, a hexagonal shape, or other polygonal shape, or a circular shape, elliptical shape, or the like.

As shown in FIG. 21, each pressure chamber 152 is connected to a common channel 155 through the supply port 154. The common channel 155 is connected to an ink tank (not shown), which is a base tank that supplies ink, and the ink supplied from the ink tank is delivered through the common flow channel 155 to the pressure chambers 152.

An actuator 158 provided with an individual electrode 157 is bonded to a pressure plate (a diaphragm that also serves as a common electrode) 156 which forms the surface of one portion (in FIG. 21, the ceiling) of the pressure chambers 152. When a drive voltage is applied to the individual electrode 157 and the common electrode, the actuator 158 deforms, thereby changing the volume of the pressure chamber 152. This causes a pressure change which results in ink being ejected from the nozzle 151. For the actuator 158, it is possible to adopt a piezoelectric element using a piezoelectric body, such as lead zirconate titanate, barium titanate, or the like. When the actuator 158 returns to its original position after ejecting ink by the displacement, the pressure chamber 152 is replenished with new ink from the common flow channel 155, through the supply port 154.

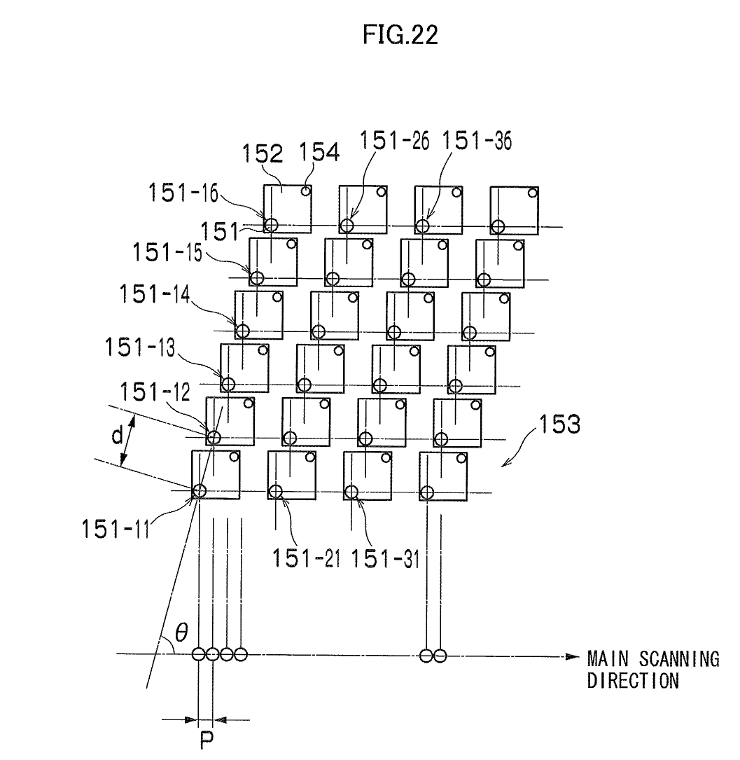

As shown in FIG. 22, the high-density nozzle head according to the present embodiment is achieved by arranging the plurality of ink chamber units 153 having the above-described structure in a lattice fashion based on a fixed arrangement pattern, in a row direction which coincides with the main scanning direction, and a column direction which is inclined at a fixed angle of 0 with respect to the main scanning direction, rather than being perpendicular to the main scanning direction.

More specifically, by adopting the structure in which the plurality of ink chamber units 153 are arranged at a uniform pitch d in line with a direction forming the angle of θ with respect to the main scanning direction, the pitch P of the nozzles projected so as to align in the main scanning direction is d×cos θ, and hence the nozzles 151 can be regarded to be equivalent to those arranged linearly at the fixed pitch P along the main scanning direction. Such configuration results in a nozzle structure in which the nozzle row projected in the main scanning direction has a high nozzle density of up to 2,400 nozzles per inch.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 151 arranged in a matrix such as that shown in FIG. 22 are driven, the main scanning according to the above-described (3) is preferred. More specifically, the nozzles 151-11, 151-12, 151-13, 151-14, 151-15 and 151-16 are treated as a block (additionally; the nozzles 151-21, 151-22, . . . , 151-26 are treated as another block; the nozzles 151-31, 151-32, . . . , 151-36 are treated as another block; . . . ); and one line is printed in the width direction of the recording paper 116 by sequentially driving the nozzles 151 -11, 151-12, . . . , 151-16 in accordance with the conveyance velocity of the recording paper 116.

On the other hand, “sub-scanning” is defined as to repeatedly perform printing of one line (a line formed of a row of dots, or a line formed of a plurality of rows of dots) formed by the main scanning, while moving the full-line head and the recording paper relatively to each other.

The direction indicated by one line (or the lengthwise direction of a band-shaped region) recorded by main scanning as described above is referred to as the “main scanning direction”, and the direction in which sub-scanning is performed, is referred to as the “sub-scanning direction”. In other words, in the present embodiment, the conveyance direction of the recording paper 116 is referred to as the sub-scanning direction and the direction perpendicular to same is referred to as the main scanning direction.

In implementing the present invention, the arrangement of the nozzles is not limited to that of the embodiment shown. Moreover, a method is employed in the present embodiment where an ink droplet is ejected by means of the deformation of the actuator 158, which is typically a piezoelectric element; however, in implementing the present invention, the method used for discharging ink is not limited in particular, and instead of the piezo jet method, it is also possible to apply various types of methods, such as a thermal jet method where the ink is heated and bubbles are caused to form therein by means of a heat generating body such as a heater, ink droplets being ejected by means of the pressure applied by these bubbles.

### Description of Control System

FIG. 23 is a block diagram showing the system configuration of the inkjet recording apparatus 110. As shown in FIG. 23, the inkjet recording apparatus 110 comprises a communication interface 170, a system controller 172, an image memory 174, a ROM 175, a motor driver 176, a heater driver 178, a print controller 180, an image buffer memory 182, a head driver 184, and the like.

The communication interface 170 is an interface unit (image input device) for receiving image data sent from a host computer 186. A serial interface such as USB (Universal Serial Bus), IEEE1394, Ethernet (registered trademark), and wireless network, or a parallel interface such as a Centronics interface may be used as the communication interface 170. A buffer memory (not shown) may be mounted in this portion in order to increase the communication speed.

The image data sent from the host computer 186 is received by the inkjet recording apparatus 110 through the communication interface 170, and is temporarily stored in the image memory 174. The image memory 174 is a storage device for storing images inputted through the communication interface 170, and data is written and read to and from the image memory 174 through the system controller 172. The image memory 174 is not limited to a memory composed of semiconductor elements, and a hard disk drive or another magnetic medium may be used.

The system controller 172 is constituted by a central processing unit (CPU) and peripheral circuits thereof, and the like, and it functions as a control device for controlling the whole of the inkjet recording apparatus 110 in accordance with a prescribed program, as well as a calculation device for performing various calculations. More specifically, the system controller 172 controls the various sections, such as the communication interface 170, image memory 174, motor driver 176, heater driver 178, and the like, as well as controlling communications with the host computer 186 and writing and reading to and from the image memory 174 and the ROM 175, and it also generates control signals for controlling the motor 188 and heater 189 of the conveyance system.

Furthermore, the system controller 172 comprises a depositing error measurement and calculation unit 172A, which performs calculation processing for generating depositing position error data from the data read in from the test pattern by the print determination unit 124, and a density correction coefficient calculation unit 172B, which sets virtual deposited droplet and calculates density correction coefficients from the information relating to the depositing position error obtained by the depositing error measurement and calculation unit 172A. The processing functions of the depositing error measurement and calculation unit 172A and the density correction coefficient calculation unit 172B can be achieved by means of an ASIC (application specific integrated circuit), software, or a suitable combination of same.

The density correction coefficient data obtained by the density correction coefficient calculation unit 172B is stored in a density correction coefficient storage unit 190.

The program executed by the CPU of the system controller 172 and the various types of data (including data of the test pattern for obtaining depositing position error) which are required for control procedures are stored in the ROM 175. The ROM 175 may be a non-writeable storage device, or it may be a rewriteable storage device, such as an EEPROM. By utilizing the storage region of this ROM 175, the ROM 175 can be configured to be able to serve also as the density correction coefficient storage unit 190.

The image memory 174 is used as a temporary storage region for the image data, and it is also used as a program development region and a calculation work region for the CPU.

The motor driver (drive circuit) 176 drives the motor 188 of the conveyance system in accordance with commands from the system controller 172. The heater driver (drive circuit) 178 drives the heater 189 of the post-drying unit 142 or the like in accordance with commands from the system controller 172.

The print controller 180 is a control unit which functions as a signal processing device for performing various treatment processes, corrections, and the like, in accordance with the control implemented by the system controller 172, in order to generate a signal for controlling droplet ejection from the image data (multiple-value input image data) in the image memory 174, as well as functioning as a drive control device which controls the ejection driving of the head 150 by supplying the ink ejection data thus generated to the head driver 184.

In other words, the print controller 180 includes a density data generation unit 180A, a correction processing unit 180B, an ink ejection data generation unit 180C and a drive waveform generation unit 180D. These functional units (180A to 180D) can be realized by means of an ASIC, software or a suitable combination of same.

The density data generation unit 180A is a signal processing device which generates initial density data for the respective ink colors, from the input image data, and it carries out density conversion processing (including UCR processing and color conversion) described in step S22 in FIG. 6 and step S32 in FIG. 10, and, where necessary, it also performs pixel number conversion processing.

The correction processing unit 180B in FIG. 23 is a processing device which performs density correction calculations using the density correction coefficients stored in the density correction coefficient storage unit 190, and it carries out the non-uniformity correction processing described in step S24 in FIG. 6 and step S34 in FIG. 10.

The ink ejection data generation unit 180C in FIG. 23 is a signal processing device which includes a half-toning processing device for converting the corrected density data generated by the correction processing unit 180B into binary (or multiple-value) dot data, and it performs the N value conversion processing (N≧2) described in step S26 of FIG. 6 and step S36 in FIG. 10. The ink ejection data generated by the ink ejection data generation unit 180C is supplied to the head driver 184, which controls the ink ejection operation of the head 150 accordingly.

The drive waveform generation unit 180D is a device for generating drive signal waveforms in order to drive the actuators 158 (see FIG. 21) corresponding to the respective nozzles 151 of the head 150. The signal (drive waveform) generated by the drive waveform generation unit 180D is supplied to the head driver 184. The signal outputted from the drive waveforms generation unit 180D may be digital waveform data, or it may be an analog voltage signal.

The image buffer memory 182 is provided in the print controller 180, and image data, parameters, and other data are temporarily stored in the image buffer memory 182 when image data is processed in the print controller 180. FIG. 23 shows a mode in which the image buffer memory 182 is attached to the print controller 180; however, the image memory 174 may also serve as the image buffer memory 182. Also possible is a mode in which the print controller 180 and the system controller 172 are integrated to form a single processor.

To give a general description of the sequence of processing from image input to print output, image data to be printed (original image data) is inputted from an external source through the communication interface 170, and is accumulated in the image memory 174. At this stage, multiple-value RGB image data is stored in the image memory 174, for example.

In this inkjet recording apparatus 110, an image which appears to have a continuous tonal graduation to the human eye is formed by changing the deposition density and the dot size of fine dots created by ink (coloring material), and therefore, it is necessary to convert the input digital image into a dot pattern which reproduces the tonal graduations of the image (namely, the light and shade toning of the image) as faithfully as possible. Therefore, original image data (RGB data) stored in the image memory 174 is sent to the print controller 180, through the system controller 172, and is converted to the dot data for each ink color by a half-toning technique, using dithering, error diffusion, or the like, by passing through the density data generation unit 180A, the correction processing unit 180B, and the ink ejection data generation unit 180C of the print controller 180.

In other words, the print controller 180 performs processing for converting the input RGB image data into dot data for the four colors of K, C, M and Y The dot data thus generated by the print controller 180 is stored in the image buffer memory 182. This dot data of the respective colors is converted into CMYK droplet ejection data for ejecting ink from the nozzles of the head 150, thereby establishing the ink ejection data to be printed.

The head driver 184 outputs drive signals for driving the actuators 158 corresponding to the nozzles 151 of the head 150 in accordance with the print contents, on the basis of the ink ejection data and the drive waveform signals supplied by the print controller 180. A feedback control system for maintaining constant drive conditions in the head may be included in the head driver 184.

By supplying the drive signals outputted by the head driver 184 to the head 150 in this way, ink is ejected from the corresponding nozzles 151. By controlling ink ejection from the print head 150 in synchronization with the conveyance speed of the recording paper 116, an image is formed on the recording paper 116.

As described above, the ejection volume and the ejection timing of the ink droplets from the respective nozzles are controlled through the head driver 184, on the basis of the ink ejection data generated by implementing prescribed signal processing in the print controller 180, and the drive signal waveform. By this means, prescribed dot size and dot positions can be achieved.

As described with reference to FIG. 18, the print determination unit 124 is a block including an image sensor, which reads in the image printed on the recording medium 116, performs various signal processing operations, and the like, and determines the print situation (presence/absence of ejection, variation in droplet ejection, optical density, and the like), these determination results being supplied to the print controller 180 and the system controller 172.

The print controller 180 implements various corrections with respect to the head 150, on the basis of the information obtained from the print determination unit 124, according to requirements, and it implements control for carrying out cleaning operations (nozzle restoring operations), such as preliminary ejection, suctioning, or wiping, as and when necessary.

In the present embodiment, the combination of the print determination unit 124 and the depositing error measurement and calculation unit 172A corresponds to the “characteristics information acquisition device”, and the density correction coefficient calculation unit 172B corresponds to the “information selection device” and “correction value calculation device”. Furthermore, the correction processing unit 180B corresponds to the “correction processing device”.

According to the inkjet recording apparatus 110 having the foregoing composition, it is possible to obtain a satisfactory image in which density non-uniformity caused by depositing position error is reduced.

### Modified Embodiment 1

It is also possible to adopt a mode in which all or a portion of the functions carried out by the depositing error measurement calculation unit 172A, the density correction coefficient calculation unit 172B, the density data generation unit 180A and the correction processing unit 180B, which are described in FIG. 23, are installed in the host computer 186.

### Modified Embodiment 2

FIGS. 18 to 23 show the composition where a test pattern is read in by a print determination unit 124 which is provided in an inkjet recording apparatus 110, and a calculation processing function for obtaining deposition error data and a calculation processing function for determining density correction coefficients are incorporated into the system controller (reference numeral 172 in FIG. 23) and/or the print controller (reference numeral 180) of the inkjet recording apparatus 110, in such a manner that the calculation processing is carried out inside the inkjet recording apparatus 110. However, it is also possible to achieve these functions by means of an image reading apparatus which is a device for reading in a test pattern. Moreover, it is also possible to perform these functions by means of an apparatus that is external to the printer so that the image data obtained from the image reading apparatus is processed.

For example, it is also possible to use a flat-bed scanner, or the like, as the image reading apparatus which reads in the test pattern. Furthermore, it is also possible to adopt a composition which uses a computer other than the inkjet recording apparatus 110, as a calculation device for analyzing the data which has been read in and calculating the density correction coefficients. In this case, a program which causes a computer to execute an image analysis algorithm used in measuring the depositing error data, an algorithm for calculating the density correction coefficients, an algorithm for correction processing of the image data, and an algorithm for converting the corrected image data to the dot data, and the like is installed in the computer, and the computer is made to function as the calculation apparatus (the image processing apparatus) by running this program.

### Modified Embodiment 3

In the respective embodiments described above, an inkjet recording apparatus using a page-wide full line type head having a nozzle row of a length corresponding to the entire width of the recording medium was described, but the scope of application of the present invention is not limited to this, and beneficial corrective effects can also be obtained in respect of banding non-uniformities in an inkjet recording apparatus which performs image recording by means of a plurality of head scanning actions which move a short recording head, such as a serial head (shuttle scanning head), or the like.

In the embodiment described above, the inkjet recording apparatus is described as one example of an image forming apparatus, but the range of application of the present invention is not limited to this. It is also possible to apply the present invention to image recording apparatuses employing various types dot recording methods, apart from an inkjet apparatus, such as a thermal transfer recording apparatus equipped with a recording head which uses thermal elements are recording elements, an LED electrophotographic printer equipped with a recording head having LED elements as recording elements, or a silver halide photographic printer having an LED line type exposure head, or the like.

Moreover, the meaning of the term “image recording apparatus” is not restricted to a so-called graphic printing application for printing photographic prints or posters, but rather also encompasses industrial apparatuses which are able to form patterns that may be perceived as images, such as resist printing apparatuses, wire printing apparatuses for electronic circuit substrates, ultra-fine structure forming apparatuses, etc., which use inkjet technology.

Furthermore, the range of application of the present invention is not limited to the correction of density non-uniformities caused by depositing position error or nozzles suffering ejection failure, and a correctional effect can also be obtained by applying a method similar to the above-described correction processing to density non-uniformities caused by droplet volume errors, density non-uniformities caused by periodic print errors, and density non-uniformities caused by various other types of factors.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image recording apparatus which records an image on a recording medium, comprising:
a recording head which has a plurality of recording elements;
a conveyance device which conveys at least one of the recording head and the recording medium so that the recording head and the recording medium move relatively to each other;
a characteristics information acquisition device which acquires characteristics information that indicates recording characteristics of the respective recording elements, the characteristics information including recording point positional information and recording-incapable element information;
an information selection device which selects the recording point positional information to be used in calculation of correction values for use in generating image data that suppresses density non-uniformity caused by the recording characteristics in accordance with the recording-incapable element information;
a correction value calculation device which calculates the correction values from the recording point positional information selected by the information selection device;
a correction processing device which corrects the image data by using the correction values obtained by the correction value calculation device; and
a drive control device which controls driving of the recording head in accordance with the image data corrected by the correction processing device.

2. The image recording apparatus as defined in claim 1, wherein the correction value calculation device calculates density non-uniformity caused by the recording characteristics of the recording elements and calculates density correction coefficients forming the correction values in accordance with correction conditions which reduce a low-frequency component of a power spectrum that represents spatial frequency characteristics of the density non-uniformity.

3. The image recording apparatus as defined in claim 1, wherein the information selection device excludes the recording point positional information corresponding to a recording-incapable element from the calculation of the correction values.

4. A method of recording an image on a recording medium by a plurality of recording elements of a recording head, while moving the recording head and the recording medium relatively to each other by conveying at least one of the recording head and the recording medium, the method comprising:
a characteristics information acquisition step of acquiring characteristics information that indicates recording characteristics of the respective recording elements, the characteristics information including recording point positional information and recording-incapable element information;
an information selection step of selecting the recording point positional information to be used in calculation of correction values for use in generating image data that suppresses density non-uniformity caused by the recording characteristics in accordance with the recording-incapable element information;
a correction value calculation step of calculating the correction values from the recording point positional information selected in the information selection step;
a correction processing step of correcting the image data by using the correction values obtained in the correction value calculation step; and
a drive control step of controlling driving of the recording head in accordance with the image data corrected in the correction processing step.

5. A computer readable medium having embodied thereon a computer program for causing a computer to operate:
a characteristics information acquisition function of acquiring characteristics information that indicates recording characteristics of a plurality of recording elements of a recording head, the characteristics information including recording point positional information and recording-incapable element information;
an information selection function of selecting the recording point positional information to be used in calculation of correction values for use in generating image data that suppresses density non-uniformity caused by the recording characteristics in accordance with the recording-incapable element information;
a correction value calculation function of calculating the correction values from the recording point positional information selected by the information selection function; and
a correction processing function of correcting the image data by using the correction values obtained by the correction value calculation function.
